(19) United States
(12) Patent Application Publication
(10) Pub. No.: US 2025/0233964 A1
(43) Pub. Date: Jul. 17, 2025

(54) COLOR PROJECTOR WITH A BEAM-STEERED ILLUMINATION AND METHOD FOR PROVIDING BEAM-STEERED ILLUMINATION TO A COLOR PROJECTOR

(71) Applicant: BARCO NV, Kortrijk (BE)

(72) Inventors: Bart MAXIMUS, Oudenaarde (BE); Daniel LAMBOT, Leuze-en-Hainaut (BE); Dries DOORNAERT, Wevelgem (BE)

(73) Assignee: BARCO NV, Kortrijk (BE)

(21) Appl. No.: 18/852,814

(22) PCT Filed: Apr. 1, 2022
(86) PCT No.: PCT/EP2022/058768

§ 371 Date: Sep. 30, 2024

(51) Int. Cl. H04N 9/31

(52) U.S. Cl. CPC H04N 9/3105; H04N 9/3152; H04N 9/3158; H04N 9/3161; H04N 9/3164

(57) ABSTRACT

A multicolored optical assembly and a method for providing highlighting to an image of a multicolored baseline projector having a baseline light beam. The optical assembly can have an optical highlighter light path providing a highlighter light beam of steered light delivered to an imager. Light loss can be reduced after a spatial phase modulator in a multicolored optical assembly i.e. to use light more effectively. A method for providing highlighting to an image of a multicolored baseline projector having a baseline light beam is provided without using polarized light.

The present invention relates to a multicolored optical assembly and to a method for providing highlighting to an image of a multicolored baseline projector having a baseline light beam, the optical assembly having an optical highlighter optical path providing a highlighter light beam of steered light delivered to an imager.

### BACKGROUND

A projector with a combination of a highlight beam and a baseline beam via angular combination is described in WO2020/057150, see FIG. 3. In the best case, the angular space taken by the highlight and baseline beams can each have a diameter half the size of the diameter corresponding to the acceptance angle of the imaging engine (see FIG. 9a of this document). It is a logical consequence that when two beams are combined by angle, they can nowhere share the same angle and, hence, cannot have overlap in this kind of angular space. This is true for telecentric beams whereas in case of a non-telecentric beam a limited overlap in the angular space can be accepted. With an omnidirectional angular spread from diffusers applied before the beam combination, the best “filling” of the imaging engine's aperture is when the highlighter and baseline beams are represented as two non-overlapping circles each having half the diameter of the full engine's aperture, i.e. according to the angle acceptance of that engine. This is, however, a theoretical maximum because, in addition, it is necessary to take into account some angular spacing necessary to avoid interference between optical components in each of the two optical paths. In such a system there is also no room for a diffusive component placed after that plane where the two beams are combined, so that it is not possible to spread out the angles more which would be good for de-speckling and peak radiance reduction in the exit pupil. This known projector arrangement is also not optimal for optical uniformity, because of an angle-dependent influence or vignetting effects of certain components in the imaging engine like a Philips prism, or the projection lens, or other components like specific apertures. In such a case some rays having certain angles are then more affected than rays having other angles. For the same reason there can then also be a difference between how the rays from the highlight beam and baseline beams are affected which may lead to artefacts in the image.

Prior art systems can typically only work well for highly polarized light in a specified direction, and every deviation from that highly polarization state will create light loss or image artefacts.

Also, prior art projectors describe how light is dumped and that this light can be recycled and possibly steered back onto a target.

Conventional light recycling is an inefficient solution since the light will have to pass through several optical components before being re-used. The light will be submitted to e.g. attenuation, absorption, or it will escape the system (e.g. via the integrator rod). In the present solution, the light can be collected without adding components in its path.

The prior art does mention the use of phase modulators, but they do not discuss collecting specularly reflected light from the phase modulator. Instead, they only refer to the conventional way of sending the light back towards the light source which can escape from the integrator rod.

A further disadvantage of prior art AM system is the limited brightness gain for the highlighter beam.

### SUMMARY OF THE INVENTION

An object of the present invention relates to providing a multicolored optical assembly and to a method for providing highlighting to an image of a multicolored baseline projector having a baseline light beam. The optical assembly can have a highlighter optical path providing a highlighter light beam of steered light delivered to an imager. The highlight path can be retrofitted to an existing baseline projector. Another object of the present invention is to minimize the light loss after a spatial phase modulator in a multicolored optical assembly i.e. to use light more effectively. Also, a method for providing highlighting to an image of a multicolored baseline projector having a baseline light beam without using polarized light is disclosed.

Embodiments of the present invention can relate to and provide one or more of the following: light projectors, especially multicolour projectors;
optical assemblies for combining and/or modulating light beams;
optical assemblies for retrofitting a highlighter optical path to an existing baseline projector;
highlight projectors especially multicolour highlight projectors;
methods for combining and/or modulating light beams;
methods for projecting images, especially projecting multicolour images.

Some embodiments of the present invention relate to generating a light beam for highlights for or in projected images by combining plural light beams into a homogenized beam (e.g. passed through an integrator) that illuminates a spatial phase modulator with which light is steered to highlight locations in an image plane.

In any of the embodiments of the present invention, a PSF of the highlighter light beam is preferably selected so that the specularly reflected or transmitted light from a spatial phase modulator can be collected, i.e. can be used or reused.

An advantage of embodiments of the present invention, is a superior brightness gain in a highlighter light beam. For amplitude modulated systems the gain in the highlighter beam is 2 times at most. When using a diffractive element this could be 4. Embodiments of the present invention can obtain a 50 times gain. This gain improvement is related to steering light so that a large amount of light can be centered on a spot in a beam steering projector. This can be achieved by converging the highlighter beam onto a spatial phase modulator and/or onto an intermediate target image.

Embodiments of the present invention have a large highlighting peak factor. Highlighting peak factor is luminance in small target divided by luminance in 100% FSW target. Summary of values for center screen are given in table 1:

| Target area | Max luminance in target | |
|---|---|---|
| 100% | 52.8 | cd/m² |
| 6.25% | 626 | cd/m² |
| 1% | 2876 | cd/m² |
| 0.04% | 5249 | cd/m² |

Table 1 shows how the maximum luminance in the target area can be significantly increased when decreasing the target area. Embodiments of the present invention can obtain a luminance of at least 4 times the initial value, for example at least 5 times, at least 10 times, at least 15 times at least 20 times, at least 30 times, at least 40 times, and a maximum 50 times.

For the highlighter light beam, multiple laser beams are preferably combined, for example, in what can be called a LDA (Laser Diode Aggregated) source where the beams are brought as close to each other as possible, i.e. via a “knife edging” technique. This combined light power enters into an integrator such as a optical fiber with an as small as possible cross section. Integrator dimensions such as optical fiber dimensions will affect the size of the PSF. After leaving the integrator such as a optical fiber, the light goes to a spatial phase modulator, color per color.

The baseline light can also come from an array of laser diodes such as a Laser Diode Aggregated (LDA) source, but since the integrator i.e. a light rod is bigger, i.e. bigger in diameter or cross-sectional area, the etendue restrictions are much less so that the aggregation is less critical. Note also that the baseline integrator such as a rod is common for the 3 colors, the integrators e.g. rods after the 3 LDAs are also 3 in total.

The plural light beams of a highlighter light beam may illuminate the same set of one or more imagers. An advantage of some such embodiments is to increase substantially a light budget available for highlighting. Any of the embodiments may include piston-based spatial phase modulators and an advantage of some such embodiments is increased reliability of the piston-based spatial phase modulators that are used for light steering.

Some embodiments of the present invention provide an optical assembly comprising a plurality of spatial phase modulators, especially piston-based spatial phase modulators, whereby each can be illuminated by a light beam from a collimated light source which does not need to be polarized. A control system may set each of the spatial phase modulators to apply phase shifts so as to steer light to a common target or image plane. The light steered by each spatial phase modulator may provide areas of greater light intensity and areas of less light intensity on a target image. Embodiments of the present invention have a spatial phase modulator that steers light to a smaller (intermediate) target image with a converging unsteered light beam and a converging steered light beam between the spatial phase modulator and the target image.

The light steered by the spatial phase modulators in each color can be combined into one highlight light beam and will then be combined with a baseline light beam where the highlighter light beam and baseliner light beam converge at an acute angle α. The beams leaving from the spatial phase modulators (e.g. one per color) for example in R, G and B are combined for example with dichroic mirrors and will share the same optical axis as the one highlighter light beam, which will combine with the baseline light beam. A first dichroic mirror can combine two primary colours such as red and green beams, a second dichroic mirror then adds the third primary colour e.g. the blue beam to the combined red and green beams.

A highlighter light beam and a baseline light beam can be combined at a target image and the combined beams can illuminate an imager which can include one or three spatial light modulators and other optical elements like a prism such as a TIR prism and a projection lens.

In some embodiments, the angle between the optical axes of the highlighter light beam and baseline light beam combining at the common target image are smaller than ½, ⅓, ¼, ⅕, ⅙, etc., of a maximum boundary of an acceptance angle of an optical system that includes the imager. In some embodiments at least one optical diffuser is provided in an optical path between the common target image and the imager. The optical diffuser preferably increases an angular spread of the combined steered light.

One aspect of the invention provides a multi-colour projection system comprising one or more light sources operative to emit light and optical elements arranged to direct the light from the one or more light sources in one or more separate collimated beams. Each of the beams for the highlighter beam illuminates the active area of a spatial phase modulator. Each of the highlighter beams converges onto a target image plane at an acute angle, preferably not exceeding 10 degrees. This target image plane is where the highlighter light beam and the baseline light beam are combined. Optical elements are provided to converge each highlighter light beam on the spatial phase modulator which itself is arranged to modulate the light of at least one of the highlighter light beams.

Another aspect of the invention provides systems and methods for supplying light for highlights in projected images. In some embodiments at least one modulated light beam (e.g. a light beam that is modulated by a spatial phase modulator) is combined with a baseline light beam (e.g. a beam that provides uniform illumination). The highlighter light beam and the baseline light beam preferably have the same or similar coverage in angular space. This advantageously allows for light from both the modulated highlighter light beam and the baseline light beam to be diffused using the same optical diffuser thereby increasing the angular extent of the combined highlighter and baseline light beams without severe loss of light.

In embodiments a baseline beam is combined with highlighter light beam, wherein the baseline light beam has coverage in angular space that is the same or is similar to that of the highlighter light beam, the highlighter light beam being generated by collecting light from separate light sources, e.g. laser light sources, onto an integrator or other means for homogenization such as an optical fiber (e.g. an optical fiber having a numerical aperture (“NA”) 0.2 and e.g. about 0.43×0.23 mm cut). Light from the SPM which is illuminated by the light from the optical fiber, and light from the baseline light beam are projected (e.g. imaged) onto a common target image plane. The cross section of the optical fiber for homogenizing the light that falls on the SPMs is preferably small, e.g. 0.43×0.23 mm or smaller and is usually smaller than the integrator rods of the baseline light path. The highlighter works best with a point source but typical highlighters according to embodiments of the present invention generate a spot rather than a point. The light rod in the baseline light path can be bigger than the optical fibers used for highlighting, and can be, for example, square in cross-section or rectangular like 2 mm×1 mm.

Embodiments of the present invention provide a method for combining highlighter light beams and baseline light beams at a location, which method provides steered light from the highlighter light beam at the location of a combination with the baseline light beam and before an angle spreading diffuser, the method comprising the following steps:

Steered light from a highlighter light beam being made by the following steps:
A multicoloured such as a three colour laser source providing a highlighter light beam to an integrator per colour such as an optical fiber per colour for making a collimated beam (e.g. with a Beam Parameter Product of less than 50 mm·mrad).
An optical system wherein, in a first option, the collimated beam is realized as a converging illumination on an active area of each spatial phase modulator and light from each spatial phase modulator converges further to a first intermediate target image,
In a second option the collimated beam is realized as a converging illumination leaving an active area of each spatial phase modulator and converging to a first intermediate target,
The first intermediate target image being smaller than the active area of each spatial phase modulator (i.e. 5%, 10% or more than 15% smaller) and the convergent illumination is realized in such a way that a specular light beam leaving each spatial phase modulator provides unsteered light, and the unsteered light is incident on the first intermediate target image and has a size on the first intermediate target image that matches with the size of the first intermediate target image. Matching means that unsteered light is landing on the target image in such a way that at least 85% of the first target image field is illuminated with at least 75% of the light intensity of the unsteered light that is incident at the center of the first intermediate target image. Preferably at least 85% of the complete flux of unsteered light is falling within the first intermediate target image area.
The method above can comprise further steps of providing an optical relay system extending from the integrator or optical fiber per colour to a spatial phase modulator per colour for converging the highlighter light beams.
Alternatively, the method above can comprise the steps of providing optics for convergence of the highlighter light beams per colour from each spatial phase modulator to the intermediate target image.
The method above comprising the steps of providing a second relay optical system that images the 1^{st} intermediate image on a 2^{nd} intermediate target image and where the beam is made telecentric.
The method above wherein three colored highlighter light beams are combined via a set of two dichroic mirrors placed in the highlighter optical path per color between the spatial phase modulator for that color and a common second intermediate image, in such a way that the three-color beams share the same optical axis when arriving at that second intermediate image. A first dichroic mirror can combine two primary colours such as red and green beams, a second dichroic mirror then adds the third primary colour e.g. the blue beam to the combined red and green beams.
The method above wherein a baseline light beam is formed from an aggregation of laser diodes with wavelengths in each primary color, all beams being collected into a homogenization optics delivering a combined beam with an etendue similar to the etendue of the highlighter light beam at the second intermediate image, and smaller than i.e. ⅛^{th} of the etendue of the of an imager and projection lens.
The method above comprising the steps of the baseline light beam and highlighter light beam being combined by angular beam combination wherein the baseline light beam and the highlight light beam share a same size area on the second intermediate target image plane, and where the highlighter light beam and the baseline light beam are combined via a small inter-beam angle which is smaller than two times the angular dimensions of the individual highlighter light beam and the baseline beam.
The method above comprising the further steps of locating a diffuser after the 2^{nd} intermediate image for spreading the beam at the plane of the 2^{nd} intermediate image in such a way that the beam spread is optimized up to the angular limits accepted by the imaging engine with the projection lens.
The method above comprising the further steps of at least one phase modulator is provided per color with an aspect ratio above 1 or different from 1 over the aspect ratio of the imager.
The method above comprising the steps of providing a piston pixel based phase modulator e.g. with non-square aspect ratio pixels such as rectangular suitable for an imager with an aspect ratio substantially higher than 1.33:1, i.e. 16:9, 16:10 or 1.896:1, as used for cinema projectors with 4096×2160 or 2048×1080 resolution.
The method above wherein the piston pixel-based phase modulator has square electrodes and square or rectangular pixels.

Embodiments of the present invention provide an optical arrangement for a projector adapted to combine highlighter light beams and baseline beams at a location, and to provide steered light from the highlighter light beam at the location of a combination of the highlighter light beam with the baseline light beam and before an angle spreading diffuser, the arrangement comprising:
A multicoloured such as a three-colour laser source providing light to an integrator per colour such as an optical fiber per colour for making a collimated beam (i.e. with a Beam Parameter Product of less than 50 mm·mrad)
An optical system wherein the collimated beam is realized as a converging illumination on an active area of each spatial phase modulator and/or a converging illumination leaving each spatial phase modulator to be incident on a first intermediate target image,
The first intermediate target image being smaller than the active area of each spatial phase modulator (e.g. 5%, 10% or more than 15% smaller) and the convergent illumination is realized in such a way that a specular light beam leaving each spatial phase modulator provides unsteered light, and the unsteered light is incident on the first intermediate target image and has a size on the first intermediate target image that matches with the size of the first intermediate target image. Matching means that unsteered light is landing on the first target image in such a way that at least 85% of the first target image field is illuminated with at least 75% of the light intensity of the unsteered light that is incident at the center of the first intermediate target image. Preferably at least 85% of the complete flux of unsteered light is falling within the first intermediate target image area.
The arrangement as above comprising an optical relay system that extends from the integrator or optical fiber per colour to a spatial phase modulator per colour.
The arrangement as above comprising a second relay optical system that images the 1st intermediate image on a 2^{nd} intermediate target image and wherein the highlighter light beam is made telecentric.
The arrangement as above comprising a combiner for the three colored highlighter light beams via a set of two dichroic mirrors placed in the optical path per color between the spatial phase modulator of that color and a common second intermediate image, in such a way that the three color beams share the same optical axis when arriving at that second intermediate image. A first dichroic mirror can combine two primary colours such as red and green beams, a second dichroic mirror then adds the third primary colour e.g. the blue beam to the combined red and green beams.
The arrangement as above comprising a baseline light beam formed from an aggregation of laser diodes with wavelengths in each of primary colors, all beams being collected into a homogenization optics delivering a combined beam with an etendue similar to the etendue of the highlighter light beam at the second intermediate image, and smaller than i.e. ⅛^{th} of the etendue of the of an imager and projection lens.
The arrangement above comprising a combiner for combining the baseline light beam and highlighter light beam by angular beam combination wherein the baseline light beam and the highlight beam share a same size on the second intermediate target image plane, and wherein the highlighter light beam and the baseline light beams are combined via a small inter-beam angle which is smaller than 2 times the angular dimensions of the individual highlighter light beam and the baseline light beam.
The arrangement above comprising a diffuser located after the 2^{nd} intermediate image for spreading the highlighter light beam and the baseline light beam at the plane of the 2^{nd} intermediate image in such a way that the highlighter light beam and the baseline light beam spread is optimized up to the angular limits accepted by the imaging engine having a projection lens.
The arrangement as above comprising at least one phase modulator per color with an aspect ratio different from 1 and different from 1 over the aspect ratio of the imager.
The arrangement as above comprising a piston-pixel based phase modulator, e.g. with a non-square aspect ratio of the pixels such as a rectangular aspect ratio, for an imager with an aspect ratio substantially higher than 1.33:1, i.e. 16:9, 16:10 or 1.896:1 as used for cinema projectors with 4096×2160 or 2048×1080 resolution)
The arrangement as above wherein the piston-pixel based phase modulator has square electrodes and square or rectangular pixels.

Further aspects and example embodiments are illustrated in the accompanying drawings and/or described in the following description.

It is emphasized that the invention relates to all combinations of the above features with one another and with any one or any combination of the features of the appended claims, even if these are recited in different claims.

### BRIEF DESCRIPTION OF THE DRAWINGS

FIG. 1 shows a schematic of a highlight and baseline illumination and a multicolour projector according to an embodiment the present invention.

FIG. 2a shows a (reflective) spatial phase modulator illuminated by a collimated parallel beam reflecting the specular reflected “unsteered” light to a target image of the same size, and having a phase grating called a software lens with a focal length f_{SW} that steers the incoming light to a single central point in the target image.

FIG. 2b shows the same (reflective) spatial phase modulator with converging illumination reflecting the specular reflected “unsteered” light to a smaller target image, for which it can be proven that the same software lens grating with the same focal length f_{SW} will now steer the light to the central point of the smaller target at smaller distance. FIG. 2c shows another way of realizing the converging of the beam from the size of the SPM to the smaller target is by providing a positive (convex) lens just in front of the SPM. In FIG. 2c, this lens is indicated by the double-arrowed line next to the SPM 52. This is the optical symbol for convex lens.

FIG. 3 shows a schematic of a highlight and baseline illumination and multicolour projector according to an embodiment the present invention.

FIG. 4 illustrates a principle of the relay optics between 1^{st} and 2^{nd} intermediate images that makes a telecentric beam at the 2^{nd} intermediate image.

FIG. 5 shows an example of the implementation of a relay optics from a telecentric to a telecentric beam with different size.

FIG. 6 shows an example implementation of a relay from a non-telecentric to a telecentric beam with different size, by changing position and prescription of one of the two lenses.

FIG. 7 is as in FIG. 6, but with the change being from a telecentric beam to a non-telecentric beam.

FIG. 8 illustrates an angular space taken by the highlighter and baseline illumination beam prior to an angle spreading diffuser.

FIG. 9a shows the angular space taken by the highlight and baseline beams, each having a diameter half the size of the diameter corresponding to the acceptance angle of the imaging engine.

FIG. 9b shows an angular spread of the combined baseline and highlight beam after the diffuser, as also visible in the exit pupil when looking into the projection lens.

FIG. 10 shows schematically a phase modulator with non-square optionally 3:4 pixel shape. The raster or grid represents a 5.4 micron pitched electrode array which acts as pistons to move micro-mirrors of size 10.8 by 8.1 micron with eight retardation levels. The piston-based phase modulators are not limited to 8 retardation levels but include 16 levels or higher.

FIG. 11 is a schematic representation of a highlight and baseline illumination and a multi-colour projector according to another embodiment of the present invention.

FIGS. 12a and 12b show examples of the angular spread of the highlight illumination beam and the baseline illumination beam in the case of the embodiments with relay optics 66 and without relay optics 66.

### DEFINITIONS

An “imager” is any device that is operable to impart a desired image (an image may be any pattern) to a beam of light. A spatial light modulator (i.e. spatial amplitude modulator may be used as an imager. For example, in a cinema projector an imager may be used to modulate light incident from one or more light sources according to image data to project images according to the image data onto a screen. The images may be static or quasi static such as a presentation with slides or may be dynamic, e.g. a video. An “imaging engine” can include further optical elements such as a prism like a TIR prism and a projection lens.

A “spatial light modulator” or “SLM” is a device that operates to apply different alterations to a property of light at different locations. Typically, a SLM comprises an array of controllable elements or “pixels” that are individually operable to alter a property of light at a corresponding pixel location. Properties of light that may be altered by a SLM include amplitude (light intensity), polarization and phase. A SLM may be transmissive or reflective but for use with laser modulators it is preferred if a spatial phase modulator is chosen that does not overheat when a laser beam is incident upon them. A transmissive SLM modulates light that is transmitted through the SLM (e.g., light is incident on one face of the SLM and modulated light is emitted from another opposing face of the SLM). A reflective SLM may modulate light that is reflected from one face of the SLM (e.g., light is incident on one face of the SLM and modulated light is emitted from the same face of the SLM). Reflective SLM's are usually preferred when used with an incident laser beam.

A “digital mirror device” (“DMD”) comprises micro-mirrors that are tilted into 2 different positions. In a first position, they reflect the light to the screen via the projection lens, in the other position, they reflect the light to a light dump, e.g. inside the projector. The pixels do not alter the amplitude/intensity of the beam, they only redirect it. On the screen these redirections make a difference of how much light arrives at each position on the screen and, hence, the amplitude of such light. DMD's are therefore spatial light modulators.

“Spatial amplitude modulator” or “SAM” means a type of SLM that is operable to controllably alter amplitude of light. Such an SAM can be transmissive or reflective. Non-limiting examples of SAMs are liquid crystal panels (also called LCDs), liquid crystal on silicon (LCoS) devices, DMD.

A “spatial phase modulator” or “SPM” (or “PLM”) is a type of SLM that is operable to controllably alter the phase of light. Non-limiting examples of SPMs are LCoS devices and deformable mirrors. Embodiments of the present invention apply SPMs that have a pitch (i.e., a spacing between adjacent pixels in rows and/or columns). Such a spacing depends on the technology used. The pixels spacing can be 10 μm or less. Some SLMs operate only to modulate light amplitude. Some SLMs operate to modulate light phase. Some SLMs operate to modulate both light amplitude and light phase. Operation of some SLMs may be dynamically controlled in real time to:
modulate light amplitude only;
modulate light phase only; or
modulate both light phase and light amplitude.

A different and more preferable MEMS-based spatial phase modulator comprises mirrors on “pistons” that can move up or down. When a micro-mirror is moved up or down perpendicular to a plane of the pixel micro-mirror array, it changes the distance that light needs to travel before it gets reflected, creating a variable “retardation” and, hence, a change of the phase of the light per pixel.

“f-number” is a dimensionless number that can be used to characterize an optical system. f-number is a ratio of a focal length of the optical system to a diameter of an entrance pupil of the optical system.

“Highlight”, in reference to a projected light field (which may include an image), means a bright spot or area or pattern or zone. Highlights may include the brightest points in a light field.

“Highlighter light beam” as used herein includes a beam of light that is configured to produce a non-uniform light field or illumination field which includes one or more highlights at a target area. In a beam steering projector the “images” are then illuminated by this “illumination field”. The target area may, for example, be a screen or image plane onto which the highlight beam is incident. The highlight beam may include areas having higher illumination intensities and areas having lower illumination intensities. For example, the highlighter light beam can be an almost uniform illumination field, just like the baseline light beam. This could be when there are no highlights in the image-like a fog scene. In that case, the highlighter light beam just contributes to the general brightness of the image everywhere in the image. The next scene could contain a highlight feature again and the beam steering is then immediately commanded to steer to provide a more suitable highlighter light beam. The highlighter light beam is generated and used by a highlight illumination part before being combined with a baseline light beam.

“Baseline projector” refers to a conventional light valve projector design with conventional illumination and, thus, without light steering or highlighting. For example, imagers can be provided by DLP, LCD, LCoS light valves.

“Baseline light beam(s)” supply enough light to an imager, substantially uniformly distributed over the imager's area, to project a desired image, without the potential addition of one or more highlighter light beams that can be modulated to supply extra light for highlights in specific regions of the projected image. A baseline light beam can provide uniform illumination as is used in a conventional projector without highlighting. There can be some deviation from a perfect uniform illumination because of optical non-idealities. This can lead to a lower than 100% uniformity, i.e. a 90% uniformity or above. Typically, there is some roll-off to the corners of the image. There are measurement procedures to characterize this (i.e. measure illuminance on screen at 13 points and report the minimum value versus the central value). The baseline light beam is generated and used in a baseline illumination part before being combined with a highlighter light beam.

“Modulate” means to vary a property of light as far as this application is concerned. Light can be modulated temporally or spatially or both. Example properties of light that may be modulated include any of, or any combination of amplitude (brightness or intensity), phase and polarization state. Spatial modulation of light can be achieved by selectively attenuating light at spatial locations (e.g., pixels) and/or by steering light. Light steering involves steering light that would otherwise illuminate some spatial locations to other spatial locations. Light steering may be achieved, for example, using variable lenses, variable mirrors or a variable array of micro-mirrors and/or spatial phase modulators (e.g., SPMs). A phase pattern applied by a SPM may direct incident light to selected regions in an image plane. Interference between different parts of the directed light may result in some locations in the image plane having more light (i.e. constructive interference) and/or some locations in the image plane having less light (i.e. destructive interference). As a result of such interference, the phase pattern applied by the SPM may effectively steer or direct incident light away from certain regions in the image plane and/or steer or direct the incident light so that light is concentrated in certain regions in the image plane.

“Numerical aperture” or “NA” for an optical system is a dimensionless number that provides a measure of the range of angles of incoming light that can pass through the optical system. NA is given by the product of the index of refraction of the medium through which incoming light arrives at the optical system and the sine of the maximum angle of light rays that will pass through the optical system relative to an optical axis of the optical system.

“Acceptance angle” for an optical system is a solid angle for which light rays entering the optical system with directions lying within in the solid angle will pass through the optical system. Solid angle may be measured in steradians. Solid angle is a valid and correct “unit” for acceptance angle, but the linear angle is often used to denote acceptance angle. For example if it is said that the acceptance angle is i.e. 10°, this points to the radius angle of the solid angle cone.

“Etendue” is a number that characterizes how “spread out” light is in area and angle. From the point of view of an optical system the etendue may be defined as the area of an entrance pupil of the optical system times the acceptance angle (as defined herein) of the optical system.

“Polarized”, “unpolarized”, “partially polarized” light are defined, for example, in en.wikipedia.org/wiki/Polarization_(waves). In the present application, “Randomly polarized” light is used here as synonym for “unpolarized” light. There is no particular functional distinction between pseudo-random and full-random polarized light as far as this invention is concerned. Both would be problematic for prior art SPMs and would be suitable for use with piston-based SPMs and for use in the embodiments of the present invention. Full- and pseudo random polarized light can be treated as the same.

The “highlighter illumination part” is a part of the projector that creates a changeable illumination profile to a set of projection imagers, in a sense that it can distribute a certain light flux in various ways over the imager, going from a uniform distribution over its complete area to one or a number of concentrated “highlight spots”, and can modify this illumination on a frame by frame basis, so that it can be synchronized with a moving video sequence provided on the baseline illumination part. The “baseline illumination part” is a part of the projector that creates a fixed illumination level with a substantially good uniformity over the whole imager area. This part is the same as a conventional projector.

Note that both parts have to provide their illumination with the additional requirement that the light after going through the one or more imagers is still accepted by the projection lens and is imaged on a screen (which means that the F-number of the illumination has to be equal or higher than the F-number of the projection optics).

For the terms Steered and Unsteered light, specularly reflected and non-diffracted light is unsteered light. Steered light is light that can get deflected away from the specular reflection direction as a consequence of the interaction with the diffraction grating on the SPM, which can then be redistributed or redirected so that one diffraction order is redistributed towards another location or other locations in the target image. The highlighter image has its designated illumination profile as produced for example with a phase grating. Redirection is normally in a direction different from that of the specular reflection. Some-rather rare-areas of the SPM could still be instructed to mainly reflect the light along the specular reflection when it is the purpose to create a highlight target exactly on that line. Those zones will have a locally “flat” area in the phase grating image with constant spatial phase modulator values. Note that the amount of unsteered light has a fixed contribution from i.e. reflection on non-active optical interfaces on the SPM, but also a varying contribution depending on the actual phase grating coming from non-optimal representations of the required retardation levels on the pixels (round-offs to a limited amount of driving levels, micro-mechanic tolerances, etc.).

### DETAILED DESCRIPTION OF EMBODIMENTS OF THE PRESENT INVENTION

Embodiments of the present invention relate to a multi-colour projector with a combination of a highlighter light beam and a baseline light beam, e.g. combined via angular combination. Any or all of the embodiments of the present invention can make use of piston shaped pixel based spatial phase modulators which are called an SPM as disclosed, for example, by the company Texas Instruments, USA. These MEMS devices can have square, e.g. 10.8×10.8 micron pixels that can be moved up and down by micro-mechanical or micro-electromechanical structures, see for example US2019/179134, US2019/179135, US2020/209614. They can have square or rectangular pixels. The term “piston” relates to any mechanism for moving each micro-mirror of a planar addressable micro-mirror array independently in a controlled up and down motion, i.e. away from and towards the plane of the planar addressable micro-mirror array. The micro-mirrors of such a device have a number of positions such as 8 or 16 (or more as technology advances) positions at different heights, thus providing 8 or 16 different levels of retardation of an incident light beam. These devices work both for unpolarized and polarized light—contrary to the LCoS based spatial phase modulators which work for light sources providing only polarized light in a specified polarization direction. This gives the opportunity to design a new projector architecture where the SPMs and the SLMs can be illuminated with unpolarized light without introducing light losses or image artefacts or increasing these. Also, it is not necessary to deal with the depolarizing effects of many optical components, like integrators, e.g. the means for homogenization, such as fibers between the laser sources and the SPM, or integrators like means for homogenizing such as a full glass light rod or even a hollow light pipe that is used to homogenize the baseline light. The image artefacts can be a consequence of depolarization effects, i.e. local depolarization. It can be that a component like a lens gets the most stress-induced birefringence in its corners. Therefore, there will be depolarization and, thus, light loss only in these areas, which would lead to dark corners in this example, or thus an issue with the quality of the uniformity of the image. Another advantage of a piston-based SPM is that the micro-mechanical structure is much more robust to incident light than the LCoS based phase modulator and will exhibit a much better lifetime for the same light load. Both effects enable an increase in the amount of light output per highlight beam leading to highlight projection architectures needing less SPMs or with a higher final light output or with a higher lifetime, or a combination of these properties.

In some embodiments of the present technology different beams of highlighter light and baseline light that have spectra but no polarization states may be combined. For example, the beams of light may all have the same specific polarization (e.g., a polarization direction matched with a polarization direction required by an imager) or may be any mix of unpolarized and polarized light, or may all be unpolarized or randomly polarised.

For example, the plural light beams may have the same or effectively the same wavelengths. Here, effectively the same wavelength means that at least 95% or at least 98% of the energy of the plural light beams is within a wavelength band that spans no more than 30 nm or no more than 20 nm or no more than 10 nm. It is preferred if there is no need for a polarizing beam splitter.

In some embodiments the light in the plural light beams is generated by plural corresponding light sources.

In some or all embodiments spatial phase modulators are controlled to steer light of the highlighter light beams.

A projection system according to embodiments of the present invention, can be a highlighter light beam and a baseline light beam converge on a first target image plane at a relative angle alpha (α), e.g. an acute angle. For example, in some embodiments alpha (α) is about 10 degrees or less or about 5 degrees or less. Each of the highlighter light beams arrives at the target image plane at an angle that is within an acceptance angle of an imager.

Embodiments provide a control system for the spatial phase modulators, whereby the control system may comprise a digital processor configured to deliver control signals to a set of pixels of the spatial phase modulators to have a desired phase pattern and to create highlight illumination profiles on a projected image. The data processor may, for example, process image data to determine a desired light steering pattern and drive the spatial phase modulators to steer light to achieve the desired light steering pattern. An overview of major elements of embodiments of the present invention are provided in the following table:

| Elements of embodiments of the present | |
|---|---|
| invention | Comments especially advantages |
| Multiple lasers in highlighter optical path | More power but bigger PSF |
| Combined in a small etendue | If the etendue is kept low enough, the PSF |
| It is instructive to look at the large | stays below 20% of the screen width which |
| differences in etendue necessary for classic | is needed to create enough highlights |
| projection and highlight projection. The | |
| illumination in a classic projector with 0.98″ | |
| imagers and F/3 has to be provided with an | |
| etendue of about 22 mm²sr. | |
| The illumination that illuminates a SPM in a | |
| highlighter optical path has to fit into an | |
| etendue of about 0.008 mm²sr in order to | |
| have a PSF of 12.5% of the screen width. | |
| If, like one aspect of any or all embodiments | |
| of this invention, the baseline illumination is | |
| combined via angle and a diffuser is located | |
| after the combination, the required etendue | |
| is of the order of 0.45 mm²sr. The large | |
| differences in etendue require a much | |
| greater care of beam quality of the lasers and | |
| how they are combined. | |
| No need for polarised light | Use piston-based phase modulators in |
| e.g. “The SPM can process unpolarized | highlighter light path |
| light” | |
| Use integrator fiber in highlighter optical | Homogenize beam over rectangular section, |
| path with rectangular cross-section - | efficient use of light |
| matches to phase modulator active area | |
| One phase modulator per colour doing light | Improvement over polarised light |
| steering (instead of 2 per color) | |
| Unsteered light is used as “quasi” uniform | Unsteered (specular) light is used as addition |
| illumination onto matched target image | to baseline beam - efficient use of light |
| thereby filling the image while the | Shorter distances to the intermediate images, |
| highlighter beam is converged. The | thus more compact light path |
| unsteered light: | (and, as a consequence, more accuracy) |
| Can spread out a little in the distance from | |
| SPM (where it was still uniformized the | |
| same as when it exited the fiber) to the | |
| target image. The unsteered light can vary a | |
| bit depending on the grating used on the | |
| SPM. | |
| But this will be covered by the separate | |
| uniform baseline light | |
| Select spacings to limit steering light from | Phase modulator acts as programmable |
| phase modulator to 1 steered diffraction | grating or dynamically addressable light |
| order | steering component |
| | No ghost illumination spots form the other |
| | diffraction orders because they fall out of the |
| | target image |
| Multiple lasers in baseline path | Greater power |
| Combine phase modulated highlighter beam | No need for polarised light |
| with baseline illumination by angle | |
| Diffuser after combination | Improved safety |
| | Improved de-speckling in the final image |
| Highlighter and baseline beams share | More efficient use of light |
| angular overlap in the exit pupil of the | |
| projection lens, thus after the light spreading | |
| by the common diffuser | |
| Use 3 SLM's such as DMD's to amplitude | sequential colour fields not so good |
| modulate combined beam for three colours | (thus better image quality for embodiments |
| and send these to projection lens | of the present invention) |
| | Higher light output possible (i.e., because |
| | thermal limitations now spread out over |
| | three components) |
| Optionally use non-square pixels on phase | Efficient use of light |
| modulator | |

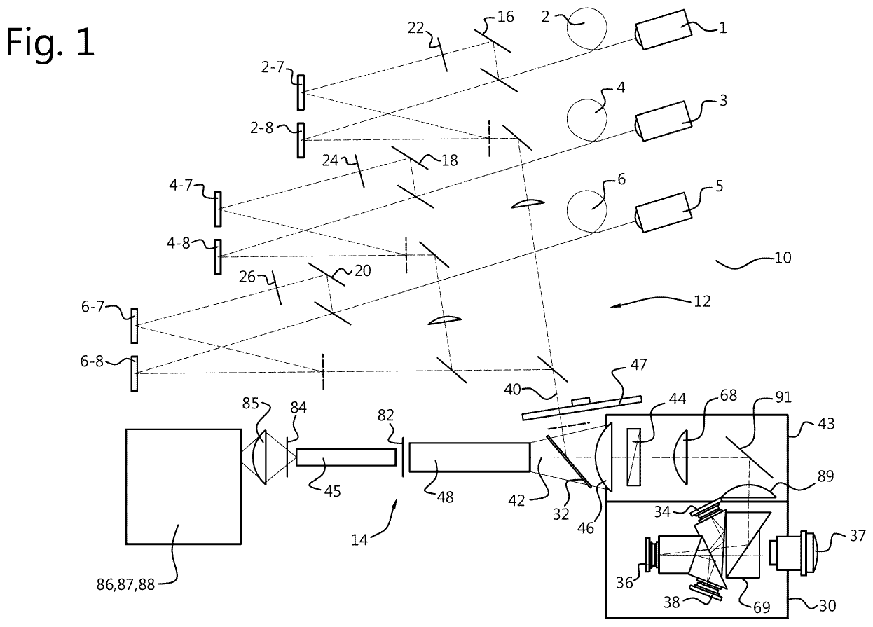

A multicolour projector 10 with highlighter light beam 40 and baseline light beam 42 and imaging engine 30 according to a fourth embodiment of the present invention is shown in FIG. 1.

The optical path 12 of the highlighter light beam 40 starts with multicolour light sources such as laser sources, in particular, Laser Diode Aggregated (LDA) light sources 1, 3, 5, e.g. of different primary colours such as red, green and blue, respectively. The light sources 1, 3, 5 such as laser sources couple their respective coloured light beams into a respective integrator as a means for homogenization such as optical fibers 2, 4, 6. These red, green, blue coloured beams can have dominant wavelengths of 639, 530, and 465 nm, respectively, for example.

Homogenization of the illumination before it is incident on the SPM (e.g. by passing the beams from the light sources through an integrator) is preferred for the highlighter light beam for the following reasons in any or all of the embodiments of the present invention (even though the projector can still work without homogenized illumination of the SPMs):
1. It gives a better power load distribution on the SPM, with a reduction or lack of local hotspots.
2. The unsteered light, which is the fraction of the light that is specularly reflected or transmitted, will largely keep the same uniformization level as on the SPM, and can then be used in the target image as a constant background illumination added to the baseline light, without creating local illumination hotspots at fixed locations or other non-uniformities.
3. The light steering can happen with a more equal contribution by all zones of the SPM, which will create the best possible illumination profile on the target image with a minimum amount of roll-off to the counters and with a minimum amount of asymmetry in the average illumination profile.

The output of each integrator such as an optical fiber 2, 4, 6 is imaged onto two spatial phase modulators per colour, 2-7, 2-8, 4-7, 4-8, 6-7, 6-8. Each light beam of one colour is first split into two paths via one of the polarization splitters 16, 18, 20 per colour. Then the polarization direction per colour of one of the two paths is rotated 90° by a half wave plate (HWP) 22, 24, 26. The beams are incident on the spatial phase modulators 2-7, 2-8, 4-7, 4-8, 6-7, 6-8, where phase differences are applied, e.g. the spatial phase modulators are configured and run dynamically by a controller which controls pixel by pixel the spatial phase modulators. (not shown). The spatial phase modulators produce the steered light which forms the highlighter light beam. Unsteered light is reflected off the spatial phase modulators specularly and follows the path of the highlighter light beam.

The two steered highlighter light beams per colour are combined in angular space and relayed to an illumination profile or first target image at a plane before reaching the imaging engine 30 which comprises the spatial light modulators 34, 36 and 38, a prism such as a TIR prism 69 and a projection lens 37.

The active areas of the spatial phase modulator 2-7, 2-8, 4-7, 4-8, 6-7, 6-8 and the first target image size can be chosen to be the same, but it is an aspect of this invention that the active areas of the spatial phase modulators are greater than the first target image size, i.e. the highlighter light beams converge onto the target image size. The light from the integrator or means for homogenization, such as fibers 2, 4, 6, is collimated, and unsteered light, which is typically a substantial fraction of the incoming light, is specular, e.g. specularly reflected and propagated further with the same degree of collimation to the first target image as the steered light. The first target image can be covered completely or less than completely and with a good level of uniformity because of the high degree of (local) beam collimation and, thus, low (local) divergence of this beam, and because of the homogenization of the illuminating beam of the SPM.

Because the basic operation of the spatial phase modulators 2-7, 2-8, 4-7, 4-8, 6-7, 6-8 in this FIG. 1 is that they function with parallel and highly collimated light, the first target image can be chosen to be the same size as the spatial phase modulator size, and the main design parameter is the distance between the two planes. The term 1X design was introduced to denote the distance in that case at which the separation between two diffraction orders of steered light (thus excluding the specular reflected unsteered light) are separated more than the largest dimension of the spatial phase modulator 2-7, 2-8, 4-7, 4-8, 6-7, 6-8 and the target image. The angle between any two adjacent “steered” orders—so excluding the specularly reflected unsteered light—is given by

$$sin ( theta ) = wavelength / pixel pitch .$$

Such formulas used in this document can make the “paraxial” approximation typically used in optics which assumes the following approximation:
sin(angle)=angle=tan(angle)
for small angles. Note that angle is expressed in radials (rad) here.

I.e., for wavelength=532 nm and pitch=10.8 micron, the angle becomes:
0.04927 rad or 2,823° via the sinus formula
0.04926 rad or 2,822° via the paraxial approximation

For instance, if the largest dimension is the spatial phase modulator width, this 1× design distance becomes D_{1×}=W·p/l, where W is the spatial phase modulator width, p is the spatial phase modulator pixel pitch and 1 is the wavelength of the light. When the distance is lower than D_{1×}, there will be more than one (steered light) order in the target image, so it is recommended and preferred to take a distance much larger than 1×, firstly in order to keep the complete spot of the next diffraction order caused by the same angular spread out of the target image, and secondly to reduce the amount of local deflection that has to be adopted to steer light over the complete target image, which will improve the steering efficiency. In this design a D_{1.5×} design, for every colour can be used.

The modulated highlighter light beam 40 can pass through a diffuser 47 before being combined with baseline light beam 42 in a combiner. Accordingly, the modulated highlighter light beam 40 of one polarization and the uniformized baseline light beam 42 are combined via a Polarization Beam Splitter 32, here used as a combiner of two substantially orthogonal polarized beams.

The baseline optical path 14 starts with multicoloured polarised laser sources 86, 87, 88 e.g. for red, green and blue light, respectively producing a baseline light beam 42. These baseline coloured beams can have dominant wavelengths of 639, 530, and 465 nm, for example, for red, green and blue respectively. Optics 85 focuses the light emitted into one or more integrators such as homogenizers such as light rods 45, 48. One or more static or oscillating diffusers 82, 84 can be placed between a first integrator or a first homogenizer such as a first optionally hollow rod 45 and a second integrator or a second homogenizer such as a second optionally hollow rod 48 and/or one diffuser 84 can be placed at the entrance to the integrator such as the first optionally hollow rod 45. The baseline light beam 42 exiting the integrator such as the homogenizer such as the optionally hollow rod 48 is combined with the highlighter light beam 40 in the combiner, e.g. Polarization Beam Splitter 32 before reaching the imaging engine 30, comprising the modulators 34, 36 and 38, a prism such as a TIR prism 69, and a projection lens 37.

Starting from the intermediate target images for the different colours in the highlighter optical path 12, two optical relays can be used to relay the image. The first relay relays the first intermediate target images to the image presented as input to the Polarization Beam Splitter 32 that combines the highlighter light beam acting as target illumination beam, and the baseline homogenized beam (e.g. homogenized by being passed through an integrator) having the same size. This step also includes the combination of the three colour paths e.g. using dichroic mirrors, so that the three first intermediate images in the three colours (e.g. R, G, B) form one common highlighter light beam image as one input to the combiner, e.g. Polarization Beam Splitter 32. A first dichroic mirror can combine two primary colour paths such as red and green beams, a second dichroic mirror then adds the third primary colour path e.g. the blue beam to the combined red and green beams.

The second optical relay 43, 46, 68, 89, mirror 91 relays the combined illumination image to the one or more spatial light modulators 34, 36, 38 such as light valves present in the imaging engine 30 such as DMDs, wherein these light valves 34, 36, 38, i.e. DLP or DMD devices, function as imagers, and then the combined beam passes through a prism 69 such as a TIR prism and reaches the projection lens 37.

One of the main drawbacks of this design is, that in order to have an efficient combination of the highlighter optical path beam 40 and the baseline light beam 42 within the accepted spatial and angular space (etendue) of the imaging engine 30, both beams have to have only one polarization, each polarization having a mutually orthogonal polarization direction. This typically reduces the amount of illumination light that can be made available inside both of these beams 40, 42 by a factor of two because of using only 1 of 2 possible orthogonal polarization states in the same beam size and angle (etendue). This also causes the susceptibility to additional losses by any depolarizing component present in all of the optical paths. Thirdly, this construction causes the highlighter light beam 40 and the baseline light beam 42 to be presented with a different polarization state to the (DLP) imager 34, 36, 38 which can lead to differences in modulation quality. For that reason, a depolarizer 44 can be implemented in the relay optics path between the 2^{nd} intermediate image 65 and the (DLP or DMD) imagers 34, 36, 38. Other embodiments of the present invention can avoid one, two or all of these disadvantages.

In this embodiment shown in FIG. 1, the highlighter optical path 12 can be actually inserted into a typical already existing baseline optical path 14, e.g. as a retrofit action, wherein light is collected into a light rod 45, 48, and the exit of that light rod 45, 48 leads to the entrance of the imaging engine 30, where it is relayed to the light valves such as spatial light modulators (e.g. DMDs) 34, 36, 38 via optics 43 comprising a set of lenses and prisms that can also split the light into three colours if it is an imaging engine 30 with three light valves such as three spatial light modulators or DMDs, 34, 36, 38. The highlight optical path 12 produces a similar size intermediate image to that of the light exiting the light rod 48 in the baseline light path 14, and these two beams from the equally sized intermediate image are combined and superimposed by the combiner e.g. PBS 32.

Embodiments of the present invention relate to adding (combining) highlight illumination functionality to a basic uniform illuminated light valve (or imager) in a projector, for the purpose of turning that projector into a High Dynamic Range (HDR) projector. The following text deals with the methods to achieve such high-quality multicolour highlighter projectors and, hence, the following text is relevant to all embodiments and is disclosed with each such embodiment.

Embodiments of the present invention provide a projector with a baseline and a highlighter optical path 12, 14 with at least one, some or all of the following features:
1) An embodiment of a multicolour projector with a baseline and a highlighter optical path, spatial phase modulators and a first target image that is preferably smaller than an active area of the spatial phase modulators (SPM), and a converging illumination of the light from that SPM that propagates so that for the light that is specularly reflected on the SPM, i.e. being “unsteered light”, it fits onto (i.e. matches) the dimensions of that first target image, —Matching means that unsteered light is landing on the first target image in such a way that at least 85% of the first target image field is illuminated with at least 75% of the light intensity of the unsteered light that is incident at the center of the first intermediate target image. Preferably at least 85% of the complete flux of unsteered light is falling within the first intermediate target image area.
2) An embodiment of a multicolour projector with a baseline and a highlighter optical path having a highlight light beam and baseline light beam that coincide on an intermediate image that is relayed to the SLM(s), that have a mutually similar and more preferably lower or much lower angular spread than accepted by the imaging engine containing the SLM(s). The angular spread of the highlight light beam and baseline light beam should be similar or the same, and both of them preferably have to be lower, e.g. much lower than the aperture of the imager system, thus the acceptance angle of the imaging engine.
3) An embodiment of a multicolour projector with a baseline and a highlighter optical path whereby after the combination of the baseline and highlight light beams, these are passed through one or more diffusive elements that spread out the light, and
4) An embodiment of a multicolour projector with a baseline and a highlighter optical path whereby the spreading out of the light by a diffusive element is up to an angle still accepted by the imaging engine and this spreading results in laser de-speckling and peak radiance reduction. Reducing the peak radiance out of the exit pupil is important for laser safety class categorization.

In some embodiments, the highlighter light beam and baseline light beam combination and the multicolour projector need not be based on a polarization of the light, so that both the incoming highlighter and baseline beams do not need to have an orthogonal polarization state with the advantage of avoiding light loss. Also, in some embodiments there is no need to use two SPMs per colour. In some embodiments of the present invention, the angular spread of the incoming highlight light beam and the baseline light beam are chosen to be smaller than the acceptance angle of the imager system, so that one or more common diffusive elements can be put after the point where beam combining of the highlighter light beam and the baseline light beam takes place, and both angular distributions of these two beams can be extended to the full or almost the full acceptance angle of the imaging engine but not beyond. This is a result of the two diffused beam spots of the highlighter and baseline light beams overlapping in this angular space. This is a much better configuration for speckle reduction, e.g. the speckle contrast is up to two times lower, and peak radiance reduction, e.g. highlight peak radiance in the exit pupil is up to four times lower. There is also less difference in impact from angle related optical effects, for instance like when there is lens vignetting happening on the highlighter light beam and baseline light beam separately.

An aspect of the highlighter light beam and the baseline light beam combination and the multi-colour projector according to some embodiments of the present invention is the use of a diffuser placed after the combination point of the highlighter light beam and the baseline light beam. This diffuser operating on the combined beam improves de-speckling and radiance out of the projector exit pupil (and therefore with improved laser safety) without losing light by diffusing it outside of the acceptance angle of the imaging engine. Diffusers also create some light loss because of absorption and back-reflection, but they are preferred in the design for de-speckling and reduction of radiation (laser safety) so one has to accept this small loss. Optionally one can make sure the diffuser is strong enough to make a good spread out of the light in angular space but not too strong so that the diffusers do not send part of the light outside of the acceptance angle.

A further aspect relevant to any or all embodiments of the present invention is making the highlight path substantially more compact.

Another aspect of any or all embodiments of the present invention is a beam steering projector using piston-based spatial phase modulators that can process unpolarized (or randomly polarized) light. The projector can be configured to combine an unpolarized highlighter light (illumination) beam with an unpolarized baseline light (illumination) beam. “Randomly polarized” light is used here as synonym for “unpolarized” light.

Some embodiments of the present invention have an advantage over prior art systems of LCoS based SPMs which can only work well with highly polarized light in a specified direction, and every deviation from that highly polarization state will create light loss or image artefacts such as local variations in the illumination level, dark and bright zones, or colored zones when these local variations are color specific, etc. Some or all of the embodiments of the present invention can make use of piston-based SPMs which can work with all polarization states including no polarization. There is no particular functional distinction between pseudo-random and full-random polarized light, but both would be problematic for LCoS SPMs and acceptable for piston-based SPMs as used in some or all of the embodiments of the present invention. Fully-random and pseudo-random polarized light are equivalent.

An SPM with piston-based pixel micro-mirrors has been disclosed by the company Texas Instruments. Such devices are disclosed in US2019/179134, US2019/179135, US2020/209614. For example, such an SPM with a piston-based pixels can be a MEMS device in which pixels, e.g. 10.8×10.8 micrometer pixels being micro-mirrors can be moved up and down by micro-mechanical structures and processes. These devices work both for unpolarized and polarized light—contrary to the LCoS based spatial phase modulators or other modulators which work only with polarized light in a specified polarization direction. Piston-based SPM is much more robust to the density and flux of the incoming light beam.

Embodiments of the present invention provide a multicolored optical assembly for providing a highlighter light beam of steered light to a first target image, comprising a baseline optical path generating a baseline light beam, the optical assembly having a highlighter optical path providing the highlighter light beam of steered light, the assembly being configured to combine the highlighter light beam of steered light with the baseline light beam to form a combined beam, the highlighter light beam being configured by the following per color:
A multicolored laser source providing light to an integrator per colour, the integrator providing a homogenized and collimated beam for each colour,
A spatial phase modulator per color in the highlighter optical path, wherein the homogenized and collimated beam for each colour is incident upon the spatial phase modulator and is phase modulated for each colour by the spatial phase modulator to form steered light, each spatial phase modulator having an active spatial phase modulator area,
the multicolored optical assembly being configured to converge steered light of the highlighter light beam to be incident on a first intermediate target image, for example by a means for converging,
wherein, in a first case an illuminated area of the converging steered light illumination incident on the first target image is smaller than the active spatial phase modulator area, and/or in a second case, converging the homogenized and collimated beam for each colour onto the spatial phase modulator can be by a means for converging,
   and, for both cases, the converged steered light illumination is realized in such a way that a specular beam of unsteered light of the highlighter light beam matches with a size of the first target image. Matching means that unsteered light is landing on the first intermediate target image in such a way that at least 85% of the target image area is illuminated with at least 75% of the light intensity of the unsteered light that is incident at the center of the first intermediate target image. Preferably, at least 85% of the complete flux of unsteered light is falling within the first intermediate target image area.

An advantage of converging the highlighter light beam when it is incident on the first intermediate target image, is the achievement of a larger highlighting peak factor, the highlighting peak factor being defined as luminance in small target divided by luminance in 100% FSW target. All embodiments of the present invention achieve a highlighting peak factor greater than 4, for example at least 5 times, at least 10 times, at least 15 times at least 20 times, at least 30 times, at least 40 times, and 50 times or less.

A lens can be used for converging steered light. A lens is a simple and economical converging device and can be configured to converge the steered light.

The highlighter light beam can be randomly polarized or is unpolarized. This results in a better efficiency in light usage.

The baseline light beam can be constructed from beams of three primary colour light sources which share a common integrator and are combined into a white beam. This reduces the number of components needed.

The highlighter light beam can have an illumination profile with a first resolution and the highlighter light beam is combined with the baseline light beam which has an even and optionally rectangular illumination profile, and wherein the combined beam is relayed to imagers that make an image having a second resolution higher than the first resolution. This provides images of superior quality.

The spatial phase modulator per colour can be a piston-based phase modulator. This allows the use of unpolarised light which increases efficiency. Also, these spatial phase modulators have a better life expectancy.

The highlighter and baseline light beams can be combined in angular space which results in a better filling of the aperture as does the combined highlighter and baseline light beams which overlap in angular space after they have been combined and passed the diffuser. At the intermediate target image where baseline and highlighter light beams are combined and before they meet a diffuser that spreads the light, both beams overlap spatially but are strictly separated in angular space.

The highlighter light beam of steered light is combined with the baseline light beam and the highlighter light beam and baseliner light beam converge at an included acute angle. This provides a compact arrangement.

An imaging engine or imager is provided and at least one diffuser is in an optical path between the first intermediate target image and the imaging engine or imager. The diffuser increases the angular spread of the combined beam.

A relay optical system is provided that images the first intermediate target image on a second target image and wherein the highlighter light beam is made telecentric. This can create more room to perform a diffusion function afterwards for de-speckling,

The first target image is smaller than the active area of the spatial phase modulator active by at least 5%, 10% or 15% or even smaller. This has a positive effect on the highlighting peak factor.

The integrator can be an optical fiber. The small sizes of such fibers create a well collimated beam, for example the optical fiber can have a Beam Parameter Product of less than 50 mm·mrad.

A cross-section of a core of the optical fiber can be rectangular. This geometric shape matches that of spatial phase modulators.

The spatial phase modulator is preferably illuminated by incoming light which is the highlighter light beam which has been homogenized and collimated for each colour and reflects specularly reflected “unsteered” light to the first intermediate target image of the same size, and wherein the spatial phase modulators are configured to steer the incoming light to a single central spot in the first intermediate target image. It is the capability of a SPM to be able to steer the light to a spot on the intermediate target image.

When the light source has extent (i.e. has bulk), like from a number of combined lasers, than this point in the target becomes a spot, with a PSF. The methods of steering the light to one point to are used to characterize the PSF=Point Spread Function. The best highlighting peak factor that can achieved by embodiments of the present invention is 50 times more light in the peak than if the light gets distributed, for example at least 5 times, at least 10 times, at least 15 times at least 20 times, at least 30 times, at least 40 times, and 50 times or less.

With a number of combined lasers and not just one, the smallest diameter on the target image becomes a spot, with a PSF. This is used when steering the highlighter light beam.

The incoming light can be the converged highlighter light beam providing a converging illumination onto the spatial phase modulator and the spatial phase modulator per colour reflects the incoming light thereby providing further converging the highlighter light beam. The more convergence can be achieved the greater then highlighting peak factor.

Convergence of the highlighter light beam to reduce it from the size of the active area of the spatial phase modulator to the size of the first intermediate target image can be achieved by providing a convex lens just in front of the spatial phase modulator. A lens is an economic and efficient means for converging.

A beam combination system can be configured to combine three coloured baseline light beams from the baseline optical path, with three colored highlighter light beams from the highlighter optical path, the beam combination system being located between the spatial phase modulator of each color and a second intermediate target image, in such a way that the three coloured highlighter light beams share a same highlighter optical path when arriving at the second intermediate target image. This makes the highlighter light path more compact.

The beam combination system can comprise a set of two dichroic mirrors placed in the highlighter optical path and configured to combine each of the paths of three primary colors into a common path e.g. with the same optical axis. This makes the highlighter optical path more compact. A first dichroic mirror is configured to combine two primaries such as red and green paths, and a second dichroic mirror is configured to also adds the third path, e.g. the blue path to the previously combined (R+G) path. Dichroic mirrors can be put at 45° so that 1 beam of 1 color just passes through and the second beam that was presented in perpendicular direction gets reflected into the same direction on the same optical axis.

The baseline light beam can be made from an aggregation of light beams with wavelengths in each of the primary colors whereby all the light beams of the aggregation are collected into homogenization optics configured to deliver a combined beam with an etendue which is the same or similar to the etendue of the highlighter light beam at the second intermediate target image, and which is smaller than ⅛^{th} of the etendue of the of an imager configured to form a final image and to provide the final image to a projection lens.

An angular beam combination system is provided where the baseline light beam and highlighter light beam share a same size on the second intermediate target image, and wherein the baseline and highlighter light beams are combined via an inter-beam angle which is smaller than two times the angular dimensions of each of the individual highlighter light beam and the baseline light beams. This is a compact arrangement.

A diffuser can be located after the first or the second intermediate target image for spreading the angles at the plane of the first or second intermediate target image in such a way that the beam spread is within angular limits accepted by the imager and the projection lens. This is an efficient use of light.

The spatial phase modulator per color works with non-polarized or randomly polarized light. This reduces light losses.

The spatial phase modulator is a programmable lens or a dynamically addressable light steering component and is configured to receive a phase grating configured to create steering of the highlighter light beam to particular zones in the first intermediate target image, and which zones are relayed, in one or more additional steps, onto an imager configured to form a final image. This provides a good highlight.

The highlighter light beam reflected or transmitted after the highlight light beam illuminates the spatial phase modulator and is reflected or transmitted and falls on the first intermediate target image in only one “steered” order, and that the unsteered light which is specularly reflected or transmitted and non-diffracted light are incident on the first intermediate target image. It is advantageous to have only one order of steered light on the target image.

One order of steered light falls on the first intermediate target image and other steered light diffraction orders are excluded from falling into the same area of the first intermediate target image. This maintains the quality of the steered light without diluting with uniform light.

The specularly reflected or transmitted unsteered light is incident on the same first intermediate target image. This provides control of the unsteered light.

Converging steered light illumination is incident onto the active area of each spatial phase modulator which can increase the highlighting peak factor.

For a projector the combined beam is relayed to an imager and the combined beam is passed from the imager to a projection lens. The advantages in how the steered light is used to create the highlights and the unsteered light is added to the baseline light beam makes for an efficient projector. The highlighting peak factor is at least 5, 10, 20, 30, 40 or a maximum of 50.

In the following a method is disclosed which has the same advantages as explained above.

Embodiments of the present invention provide a method for providing a highlighter light beam of steered light to a first intermediate target image, comprising the steps of:
a baseline optical path generating a baseline light beam,
a highlighter optical path providing the highlighter light beam of steered light,
combining the highlighter light beam of steered light with the baseline light beam to form a combined beam, the highlighter light beam being configured by the following the steps of, per color:
   a multicolored laser source providing light to an integrator per colour, the integrator providing a homogenized and collimated beam for each colour,
   a spatial phase modulator per color in the highlighter optical path, wherein the homogenized and collimated beam for each colour is incident upon the spatial phase modulator and is phase modulated for each colour by the spatial phase modulator to generate steered light,
   each spatial phase modulator having an active spatial phase modulator area,
   the highlighter light beam being realized as a converging illumination onto a first target image,
wherein for a first case an illuminated area of the converged steered light illumination which is incident on the first target image is smaller than the active area of the spatial phase modulator
and/or in a second case, converging the homogenized and collimated beam for each colour onto the spatial light modulator,
and for both cases the converging illumination is realized in such a way that a specular beam of unsteered light of the highlighter light beam is incident on and matches with a size of the first intermediate target image. Matching means that unsteered light is landing on the first intermediate target image in such a way that at least 85% of the target intermediate image ara is illuminated with at least 75% of the light intensity of the unsteered light that is incident at the center of the first intermediate target image. Preferably, at least 85% of the complete flux of unsteered light is falling within the first intermediate target image area.

The converging steered light illumination is preferably incident onto the active area of each spatial phase modulator.

A lens can be used for converging the steered light.

The highlighter light beam can be randomly polarized or is unpolarized.

The baseline light beam can be constructed from beams of three primary colour light sources which share a common integrator and combining the beams of the three primary colour light sources into a white beam.

The highlighter light beam can have an illumination profile with a first resolution and the highlighter light beam can be combined with the baseliner light beam which has an even and optionally rectangular illumination profile, the combined beam is relayed to imagers that make an image with a second resolution higher than the first resolution.

The spatial phase modulator per colour can be a piston-based phase modulator.

The highlighter light beam and the baseline light beam can be combined in angular space.

The combined highlighter light beam and the baseline light beam overlap in angular space after they have been combined and passed a diffuser. At the target image where baseline and highlighter light beams are combined and before they meet the diffuser that spreads the light, both beams overlap spatially but are strictly separated in angular space.

The highlighter light beam of steered light can be combined with the baseline light beam and the highlighter light beam and baseliner light beam converge at an included acute angle.

An imaging engine or an imager can be provided, wherein at least one diffuser is in an optical path between the first intermediate target image and the imaging engine or the imager, wherein the diffuser increases the angular spread of the combined beam.

Relay optics or a relay optical system can be provided that images the first intermediate target image on a second intermediate target image and wherein the highlighter light beam is made telecentric.

The first target image is preferably smaller than the active area of the spatial phase modulator by at least 5%, 10% or 15% or lower.

The integrator can be an optical fiber. The optical fiber can have a Beam Parameter Product of less than 50 mm·mrad.

A cross-section of a core of the optical fiber can be rectangular in cross-section.

The spatial phase modulator can be illuminated by incoming light which is the homogenized and collimated beam and this for each colour and the spatial phase modulator reflects specularly reflected or transmitted “unsteered” light to the first intermediate target image of the same size, and steering the incoming light to a single central spot in the first intermediate target image.

It is the capability of a SPM to be able to steer the light to one point in the target image if the incoming light is perfectly collimated (no divergence at all, so coming form an ideal point source). When the light source has extent, like from a number of combined lasers, than this point in the target becomes a spot, with a PSF. PSF is used in the method of steering the light to one point to characterize the PSF=Point Spread Function, the best highlighting peak factor that can be achieved with embodiments of the present invention is 50 times more light in the peak than if the light gets distributed, for example at least 5 times, at least 10 times, at least 15 times at least 20 times, at least 30 times, at least 40 times, and maximum 50 times.

The incoming light is the converged highlighter light beam incident onto the spatial phase modulator and comprising reflecting or transmitting the incoming light by the spatial phase modulator per colour thereby providing further converging of the highlighter light beam.

The converging of the highlighter light beam is realized to reduce from the size of the active area of the spatial phase modulator to the size of the first intermediate target image, e.g. by providing a convex lens just in front of the spatial phase modulator.

A beam combination system is provided that is configured to combine three coloured baseline light beams from the baseline optical path, with three colored highlighter light beams from the highlighter optical path, the beam combination system being located between the spatial phase modulator of each color and a second intermediate target image, in such a way that the three coloured highlighter light beams share the same highlighter optical path when arriving at the second intermediate target image.

The beam combination system can comprise a set of two dichroic mirrors placed in the highlighter optical path to combine the beams of three primary colours into a common path with the same optical axis.

A first dichroic mirror can combine two primary colours such as red and green beams, a second dichroic mirror then adds in the third colour, e.g. the blue beam, to the combined red and green beams.

The first or second dichroic mirrors can be put at 45° to the incident beam direction, so that one beam of one color passes through the first dichroic mirror and the second beam that is incident in perpendicular direction, is reflected into the same direction on the same optical axis.

The baseline light beam can be made from an aggregation of light beams with wavelengths in each of the primary colors, whereby all light beams of the aggregation are collected into a homogenization optics delivering a combined beam with an etendue similar to the etendue of the highlighter light beam at the second target image, and smaller than ⅛^{th} of the etendue of the of an imager that forms a final image and a projection lens.

An angular beam combination system is provided wherein the baseline light beam and highlighter light beam share a same size on the second intermediate target image, and wherein the baseline light beam and the highlighter light beams are combined via an inter-beam angle which is smaller than two times the angular dimensions of each of the individual highlighter light beam and the baseline light beam.

A diffuser can be located after the first or the second intermediate target image for spreading the angles at the plane of the first or second intermediate target image in such a way that the beam spread is up to angular limits accepted by the imager and the projection lens.

The spatial phase modulator per color works with non-polarized or randomly polarized light.

The spatial phase modulator is a programmable lens or a dynamically addressable light steering component and is configured to act like a phase grating that will create steering of the highlighter light beam to particular zones in the first target image, and are relayed, in one or more additional steps, onto an imager that forms a final image.

The highlighter light reflected or transmitted after the highlighter light beam illuminates the spatial phase modulator is reflected or transmitted and falls on the intermediate target image in only one “steered” order, and that the unsteered light which is specularly reflected or transmitted and non-diffracted light are incident on the first intermediate target image.

The combined beam is relayed to an imager and the imaged combined beam is passed from the imager to a projection lens to form a projector.

Embodiments of the present invention provide projectors where the SPMs and the SLMs can be illuminated with unpolarized light without introducing light losses or image artefacts, and where it is not necessary to deal with the depolarizing effects of many optical components, like the integrator such as the homogenization optical fiber between the laser source and the SPM, or an integrator such as the full glass light rod that is used to homogenize the baseline light beam or a hollow light rod for the same purpose.

Another advantage of piston-based SPMs is that the micro-mechanical structure is much more robust to incident light than modulators such as LCoS based phase modulators and will exhibit a much better lifetime. Both effects enable an increase of the amount of light output per highlighter light beam leading to highlight projection architectures needing less SPMs or with a higher final light output or with a higher lifetime, or a combination of these properties.

Embodiments of the present invention provide an HDR (High Dynamic Range) beam steering projector with mixed highlighter and baseline illuminations using robust piston-based spatial phase modulators. These modulators can have a better performance, e.g. having an improved lifetime in all colours but especially for the colour blue. Embodiments of the present invention also provide a method that keeps the highlighter path small and compact, so that it can be better integrated despite the less favourable larger pixel pitch of these piston-based spatial phase modulator devices which can be used.

Embodiments of the present invention provide a multi-coloured projector and method of constructing and operating the same. For example, an LCoS prior art device can have a 3.8 micron pitch, whereas the MEMS and piston-based SPM can have a larger pitch such as 10.8 micron pitch which is 2.8 times larger resulting in a 2.8× smaller steering angle range. Embodiments of the present invention use a highlighter and a baseline optical path with non-polarized light.

This involves one or more or all of the following features:

Using a beam steering component for embodiments of the present invention with highlighter and baseline light beams, that works for non-polarized or random polarized light, has, for example, a number of new advantages. This is by making a highlighter light path using one or more or all of the following features:
A highlighter optical path for retrofitting to an existing baseline projector;
A projector with a highlighter and baseline light beam which implements a first intermediate target which is smaller than the spatial phase modulator,
A projector with a highlighter and baseline light beam which implements a converging illumination of a spatial phase modulator so that the specular reflection propagates to the first target intermediate image so that the sizes substantially match. The size of the beam of the unsteered light preferably matches with the size of the target image, at the location of the target image. Matching means that unsteered light is landing on the first target image in such a way that at least 85% of the target image field is illuminated with at least 75% of the light intensity of the unsteered light that is incident at the center of the first intermediate target image. Preferably at least 85% of the complete flux of unsteered light is falling within the first intermediate target image area.
Note that the unsteered light beam is very well collimated so that it only blurs out a limited amount when arriving at the target image, namely with a blurring of the same size as the PSF, e.g. 12% of the screen width. The term “well-collimated” mean that the beam has a very small divergence at every small zone (or point) of the beam. So it could be a non-parallel beam (parallel beam and collimated beam are often used as synonyms) such as a converging beam but a local zone of the beam that lands on a local zone of the SPM needs to have a small “local” divergence angle. Because it is that “local” divergence that will determine the size of the PSF when the light propagates from the SPM to the first intermediate target.
So, a converging beam means that the envelope of the beam is converging and collimated beam in this context means that any small zone inside of the beam still has a very low “local” divergence. For instance, the beam envelope (“global”) convergence angle can be 1° and the “local divergence” can be 0.1°. The purpose is thus to have the beam of unsteered light propagate to the target image—with only limited amount of blurring, so that it “fits” or “matches” to the size of that target image. This can be done by providing a converging illumination already to the SPM and the SPM just reflects it—further converging the beam. Matching means that unsteered light is landing on the first target image in such a way that at least 85% of the target image field is illuminated with at least 75% of the light intensity of the unsteered light that is incident at the center of the first intermediate target image. Preferably at least 85% of the complete flux of unsteered light is falling within the first intermediate target image area.
A projector with a highlighter and baseline light beams which has a parallel (or even diverging) illumination to the SPM and putting a convex lens in front of it so that the parallel beam is turned—in two passes before and after being reflected by the SPM—to a converging beam with the correct convergence angle.
The first method can be preferable because it does not need an extra lens in front of the SPM, but it is certainly the case that also the second method, or even other methods, are included in the scope of the present invention.
A projector with a highlighter and baseline light beam which implements the converging illumination preferably so that light specularly reflected from the full SPM surface will propagate to the first image target plane and fit into the dimensions of that first (intermediate) target image that is smaller than the SPM.
A projector with a highlighter and baseline light beam wherein the degree of matching between the unsteered light beam and the target image can be evaluated by putting a flat grating (a grating with the same retardation value on every pixel) on the SPMs. It should be landing on the target image in such a way that at least 85% of the target image field is illuminated with at least 75% of the intensity at the center of the target image, and that at least 85% of the complete flux of unsteered light is falling within the first intermediate target image area.
This means that the unsteered image is preferably not too small, so that too much side and corner areas are under illuminated, but also that the unsteered image is preferably not too large so that it is avoided that too much unsteered light would fall next to the target image and would thus be lost.
There is also another motivation to make the spot of the unsteered light at the target image small enough, thus meeting specifically the criteria described above on the total light flux is falling inside the first target image area. The reason is that steered light can be considered as a deflection from the unsteered (specularly reflected) light path, caused by the local grating put on the SPM, and the efficiency of this steered light will be higher when the specularly reflected light is already converging to the smaller first target image and not away from it. This gives the steered light already a first push in a good direction, and results in the remaining deflection angle being smaller which means the steering efficiency will be higher.

Embodiments of the present invention can implement baseline and highlighter light beams that are both working with non-polarized light and are designed/adapted to provide a combined beam with the same or a similar small amount of angular spread so that they can be combined via angular combination, and so that after the combination they can share the same diffuser, for reasons of a maximum de-speckling and a maximum radiance reduction in the exit pupil (for laser safety).

In embodiments of the present invention for a projector with a highlighter and baseline light beam, wherein the baseline optical path 14 can contain a light rod 48 whose exit is optically relayed to the entrance of the imaging engine 30 with a spatial magnification factor, so that the angular spread of the baseline light beam 42 is strongly reduced so that angular combination with the highlighter light beam 40 is possible. A further angular spread can be provided for some or all embodiments of the present invention, by one or more common diffusers 49 located after the combination point of the highlighter and baseline light beams. It is possible to then choose a custom size of image at the entrance of the imaging engine 30, but it is beneficial to keep the same size as for a “classic” baseline only projector design without highlight illumination, because of thereby keeping the imaging engine 30 equal and modular, and because the optical components of that imaging engine 30 have been optimized for the chosen size of imagers (e.g. 0.98″ or 1.38″ or other sized DLPs 34, 36, 38). The size of a DLP or DMD or other imager is most commonly expressed by its diagonal size in inch. Because one role of the diffuser is to reduce radiance in the exit pupil, for achieving a certain lower laser safety class for the device (i.e. class 1), the diffuser can be split into two in order to avoid the situation that one diffuser breaks and creates an unsafe radiance. When split into two diffusing elements then it is no longer a single fault condition event that creates this problem of too high radiance.

In a second embodiment, a projector with a highlighter and baseline light beam whereby at least one spatial phase modulator is chosen to have a non-square such as a rectangular aspect ratio such as a 3:4 pixel aspect ratio in order to further reduce the optical path and the minimum spot size of the highlight illumination on the imager(s). This illumination spot with minimum spot size is called the PSF (Point Spread Function) e.g. in a HDR (High Dynamic Range) beam steering projector. A mix of SPMs are included within the scope of the present invention for some or all of the embodiments of the present invention, such as SPMs with square pixels for some colors, with rectangular pixels in some other colors.

In yet a further third embodiment, one of the optical relays on the highlighter light path, namely the relay optics from the first to the second intermediate image, is omitted, which means that the spatial phase modulators are steering their light directly to a target image at the entrance of the imaging engine 30. The dimension of the entrance of the imaging engine 30 is typically smaller than the spatial phase modulator. Hence, also here the converging and uniform illumination of the spatial phase modulatorse is advantageous for the image quality, compactness and efficiency. The image quality aspects can again comprise consistency of the maximum highlight illumination over the whole image, dark zones and bright zones, etc. The disadvantage of this simpler highlighter optical path is that the angular spread of the highlighter light beam becomes larger, because of the lack of an optical relay step that could have made the beam telecentric at the entrance plane of the imaging engine and, hence, limit the angular extent. There is, herefore less angular room for the diffuser activity after the combination of the highlighter and baseline light beam, as preferred for de-speckling and reduction of the radiance in the exit pupil. When the highlighter and baseline light beams of a projector would have a smaller angular extent, they can also be more closely spaced in angular space for the angular beam combining, and it would then be possible to pick a stronger diffuser to spread the light up to the limit of the accepted angle of the imaging engine, and there will be better overlap between the angular spread after the diffusing. When steering directly to the entrance of the imaging engine and skipping the optical relay that makes the beam telecentric, the benefits brought by that extra relay optics that is described above for the second embodiment are lost.

With reference to some or all embodiments of the present invention, the range of the angular spread at the phase modulator plays a role in the capability of achieving a high-quality beam steering. There is no strict threshold on this angular spread itself, but it is a consequence of the spread at the first target image, where the angular spread at (each point of) the SPM (Spatial Phase Modulator) will determine the size of the illumination spot in the target (the PSF).

The following text deals with further methods to achieve high-quality multi-colour highlighter projectors and is relevant to some or all embodiments and is disclosed with each such embodiment.

A starting point in accordance with a method and system for controlling the quality of a highlight, is to select the position of a target image at a certain distance from the SPM, because it is preferred to get only one strong “steered” diffraction order in the target image, and not any other diffraction orders (i.e. diffraction orders like −3, −2, +2, etc . . . ). This means this distance is preferably or should be at least D=width_target/(wavelength/pitch_SPM), so that all SPM pixels can “reach” all target locations still with the main steered diffraction order (i.e. the first diffraction order). This is called a “1× design”. It is preferred to add some extra distance to this “1× distance” in order to have better efficiency and to have no issues with the spread around closest other higher order falling next to the target. A 1.1× design can be used where D is thus 1.1 times larger than the formula above would require. This is called the 1.1× which is called the “Design Factor” (DF).

The PSF spread is then given by distance multiplied by angular spread at the SPM, and that PSF spread should be compared to the width of the target. If the PSF is too big, the beam steering capabilities drop rapidly. In an extreme example, if the PSF is 100% of the target size it is no longer of any use to do beam steering, as the whole illumination spot just illuminates the whole panel de facto anyhow.

A generic formula for the PSF is given below and this formula's result is independent of the size of the first intermediate target image vis-à-vis of the size of the SPM. Hence, there is no requirement in this formula to have the size of the SPM equal the size of the first target. Thus, the first target's image size can be reduced while adapting the illumination on the SPM to still capture the unsteered light in it while additionally capturing a better steered light efficiency.

Note that in the PSF formula below, there is the expression NA_fib*W_fib which is one expression of the “optical invariant” principle, in this case expressed in 1 dimension, similar to a beam quality property called BPP or Beam Parameter Product. This “optical invariant” appears in all the stages of a lossless optical imaging design like a relay optics. The NA or Numerical Aperture should be interpreted as an (half) angle here, in “paraxial spirit” (sin(alpha)=alpha=tan(alpha) for small alphas, which is an approximation that can be used for any of the embodiments of the present invention). So, 2*NA_fib*W_fib can be replaced by alpha_SPM*W_SPM, with alpha=angular spread.

One can prove that for a uniform illuminated PLM system, i.e. via a fiber with NA_{fib} and width W_{fib}, the PSF-percentage and the Angular spread in any target image are following these two equations:

$$PSF ( \% ) = 2 {NA}_{fib} * {W}_{fib} / λ * DF / HRES + Δ {PSF ( \% )}_{opt} \\ Ang H = λ / {W}_{img} * HRES / DF$$

The angular spread is calculated before any diffuser in any focal place and becomes very relevant when using a HL+BA beam combination method via angular combination. For this, it is advantageous that one of the optical relays makes the beam telecentric before beam combination. The diffuser in the focal plane is used to decrease radiance in the exit pupil below laser safety limits and to decrease speckle.
PSF (%): width of the PSF expressed against the screen width
DF: Design Factor, the factor with which the diffraction orders are spread vs the image width
HRES: horizontal resolution of the PLM in number of pixels
ΔPSF (%): extra increase of the PSF caused by all the relay legs
Ang_H: angular spread of the beam at the target image width W_{img}

To conclude, for a beam steering architecture, selecting a maximum for the PSF is a starting point for some or all of the embodiments of the present invention. This value is selected as between 10-40% of the image width, or 10-35% or 10-30% or 10-15%. The larger the PSF, the more distributed the highlight becomes and, thus, the lower the highlight peak factor will be inside this highlight, and the less intense the highlights can be made.

Reshuffling the formula above, using the notion of the optical invariant that 2NA_fib*W_fib=alpha_SPM*W_SPM (alpha=angular spread here), and neglecting the extra optical blurrings that increase the PSF size, one gets:

$$alpha\_SPM \_max = PSF\_max / W\_SPM * lambda / DF * HRES$$

For a 0.98″ SPM and 2048 horizontal SPM-pixels (HRES=2048), W_SPM=22.1 mm, lambda=532 nm (green), Design Factor DF=1.1, and thus PSF_max=0.35 this gives alpha_SPM_max=0.0163 rad or 0.94°. Of course a PSF=35% is a very large value which will have a lower quality highlight as a consequence. For a better quality a PSF=12% could be selected and, thus, an angular spread on the SPM then limited to 0.32°, or 0.0056 rad (5.6 mrad).

The threshold value of the angular spread on the SPM thus depends on the exact design of the SPM and, for instance, on which SPM is used (size, number of pixels, pixel pitch). It is the final PSF size as percentage of the target on the image which is relevant for the peak factor of the highlight and a low PSF width is beneficial for a high highlight peak factor. With realistic parameters on the SPM (size, number of pixels, pixel pitch), the DF (which is at least >1), visual wavelengths (440-650 nm), an angular spread of the incident light on the SPM should be below and preferably well below 5°.

Summarising the above, a method 200 described below can be used in any of the embodiments of the present invention.

In step 201 a position of a target image is selected at a certain distance from an SPM in a highlighter optical path to get only one strong “steered” diffraction order in the target image, excluding other diffraction orders.

In step 202 this distance from the SPM is set at least to D=width_target/(wavelength/pitch_SPM), so that all SPM pixels can “reach” all target image locations still with only the main steered first diffraction order.

In step 303 The PSF spread is calculated by distance multiplied by angular spread at the SPM.

In step 204 PSF spread with the width of the target is compared.

In step 205, the maximum PSF allowable is selected. This value is selected as between 10-40% of the image width, or 10-35% or 10-30% or 10-15%. The larger the PSF, the more distributed the highlight becomes and, thus, the lower the highlight peak factor will be inside this highlight, and the less intense the highlights can be made.

In step 206, the first target's image size is reduced while adapting the illumination on the SPM to capture the unsteered light.

In step 207, an angular spread of the highlighter light beam before any diffuser in any focal plane is calculated.

In step 208, an optical relay is optionally configured to make the highlighter light beam telecentric before beam combination with the baseline light beam.

In step 209, a diffuser is configured to decrease radiance in the exit pupil below laser safety limits and to decrease speckle.

In step 210, set realistic parameters on the SPM such as size, number of pixels, pixel pitch, visual wavelengths, an angular spread of the incident light on the SPM.

In step 211, spatial phase modulators are positioned in the highlighter optical path to dynamically alter phase values pixel-by-pixel to generate highlights which illuminate imagers that create the final image.

There are two approaches for beam steering projectors using spatial phase modulators implemented in any or all of the embodiments of the present invention.

The first approach relates to a high-quality multicolour highlighter projector which uses only a phase modulator stage and no “clean-up” imager stage, so that the spatial phase modulator directly creates a final high resolution. This clean up stage is usually performed by a spatial amplitude modulator which dumps parts of the highlight which is in the wrong place, but is in this approach thus not present. The illumination profile created by the SPM at the target image is thus directly the final image which will be projected on a screen. This approach can only work if the PSF is kept very small, e.g. 0.05% of the image width, because there would be “room” for a large number such as 2000 individual steering spots (“pixels”) horizontally and a good 1100 “pixels” vertically which is HDTV resolution. This is only possible with single lasers that can be extremely well collimated and there is no need for combining beams from many lasers such as laser diodes. This requires a beam divergence angle of less than 0.001° or, thus, 4 arc seconds. This is not possible for a beam made from multiple lasers and is already a challenge for a beam made from one diode laser. It could work with a single DPSS laser (with low power <1W). This “direct beam steering” can be used, for example, for car windshield HUD projectors, used to show speed and GPS information for example, which needs to be very bright but not so finely detailed. For such a system an imager is not required.

The second approach, which is preferred for some or all of the embodiments of the present invention, phase modulators are used to illuminate imager(s) that create the final image and that—as a matter of speaking—clean-up the blurry/vague illumination profile (see U.S. Pat. Nos. 9,936,715 and 10,477,170). Hence, there are 2 stages, and one is a clean-up imager that makes the detailed image, the PSF can grow, so that its BPP can become bigger and contain much more power. At the expense of having a PSF >>0.05%, but that is acceptable because there is a clean-up image. The illumination is allowed to be blurry.

A particular feature of some or preferably all embodiments of the present invention, is to have an as compact as possible architectural implementation of the beam steering. This can be done by allowing the target image to be smaller than the SPM with a converging illumination.

In embodiments of the present invention the image formed by the steered light and by the unsteered light can have substantially the same size (i.e., the outer size thereof), and the same location. In embodiments of the present invention, both the unsteered light and the steered light are directed to the same intermediate target image, where the unsteered illumination image just adds up with the baseline illumination light of the baseline light beam. Both of these are expected to have a good degree of uniformity, while the steered illumination image can then be used to provide a very high illumination (i.e. 10 times higher, or more) in some areas where there need to be highlights, depending on whether the image to be displayed contains such highlights. In this way, no light gets lost both with regard to the unsteered and steered light, and also the unsteered light is thus fully used and not dumped. This addition is a more efficient use of a part of the highlighter light beam.

In one embodiment of the invention, a multicolour projector architecture is described with a highlight illumination part and a baseline illumination part. The highlight illumination part has a highlight light beam and a highlight illumination path for color projection that is constructed with at least one spatial phase modulator per color and at least one highly collimated light source illuminating a spatial phase modulator so as to create a substantially uniform light beam providing an illumination with a very small amount of angular spread at each point of the spatial phase modulator. So, a blue-light source is used for one SPM, a green-light source is used for another SPM, and a red-light source is used for a third SPM. The light sources can be for example laser or laser diodes.

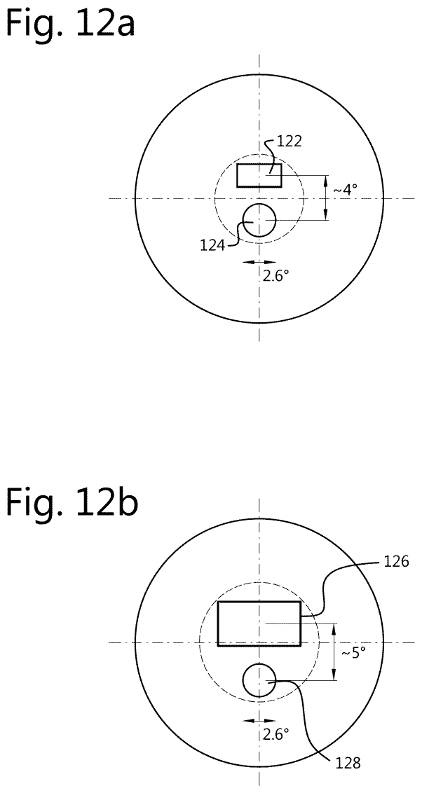

This embodiment also includes a baseline light beam provided by the baseline optical illumination path providing a uniformized beam at an optical plane with the same beam size as the highlighter light beam and a similar amount of angular spread (e.g. not less than ½ of the angular spread of the highlight beam, and not more than two times the angular spread of the highlighter light beam). This can be expressed as solid angles and then a ratio between them being between ¼ and 4. The angular spread profiles of the highlighter light beam and baseliner light beam may have a different shape, see the respective spots 122 and 124 in FIG. 12a or 126, 128 of FIG. 12b. In case of the highlighter light beam, all light rays come from the SPM so the envelope is rectangular like the SPM pixel, e.g. piston based pixel. In case of baseline light beam, this light comes from an integrator such as a homogenizer like a light rod and the angular spread is determined by the angles with which light enters that light rod. I.e. if a diffuser is used at the entrance this can be a circular shape, bit also an elliptic, square or rectangular envelope shape is possible.

For that reason, one can compare “angular 2D surfaces” with each other which are then quite equal to “solid angles”. In that case, it is needed to go for the square of a factor ½ and 2 or thus ¼ and 4 because it is now in 2D dimensions.

The spatial phase modulators used in the highlighter optical path (at least one or only one per color) preferably work with non-polarized light or randomly polarized light, so that the incident highlighter light beam does not have to be polarized or split up into two beams with orthogonal polarizations. A spatial phase modulator can be considered as a programmable lens or dynamically addressable light steering component and can receive a phase grating that will create steering of the light to particular zones in a target image, that can then be relayed, in one or more additional steps, onto an imager that forms the final high-resolution image. For a grating, a set of digital values is loaded to the SPM, which contain the description of a phase grating divided over all the pixels of the SPM. This happens via the driver of the SPM (e.g. the digital values therefor being executed by a controller) that loads such a 2D phase grating signal into the SPM. In the SPM, the digital values can be translated to voltages and addressed to the different pixels. These voltages will cause different movements of the electrodes and cause different wave front retardation values to occur for the different pixels, and in combination with the wavelength of the light this will cause differences in phase.

It is important however to consider that light from an illuminated spatial phase modulator is reflected (or transmitted) in different orders. For this embodiment, or for some or all embodiments it is preferred if only one “steered” order is used and falls on an intermediate target image, and that the specularly reflected and non-diffracted light, also called unsteered light, is still reaching the intermediate target image.

This specular reflected light or unsteered light is a result of non-idealities in the phase grating profiles, plus other specular reflections on interfaces before the light has gone through the phase modulating layer (i.e. a cover glass interface).

In this embodiment, the spatial size of the first intermediate target image is chosen to be smaller, more preferably substantially smaller, than the spatial size of the spatial phase modulator. The smaller values, i.e. of the spatial sizes, are with respect to the diagonal. Preferably the dimensions on the diagonal of the first intermediate target image are at least 10% smaller, e.g. up to 15% or at least 20% smaller, or more than the spatial size of the of the spatial phase modulator, i.e. diagonal. For example for a 0.98″ SPM and a 0.49″ first target image, the first target image is 50% smaller. For example, the range of the first target image can be from 10 to 60% smaller. Another specific arrangement in this embodiment, is that the highlighter light beam, that illuminates the spatial phase modulator, is both uniformized and converging in such a way that the (still highly collimated) unsteered light is forming a substantially uniform illumination image matched in size to the first target image which is smaller than the active area of the relevant SPM. Unsteered light can be measured by putting a flat grating (a grating with the same retardation value on every pixel) on the SPMs. An aspect of any or all of the embodiments of the present invention is that unsteered light should be landing on the target image in such a way that at least 85% of the target image field is illuminated with at least 75% of the intensity at the center of the target image, and that at least 85% of the complete flux of unsteered light is falling within the first intermediate target image area.

This means that the unsteered image cannot be too small, so that too much side and corner areas of the target image are under illuminated because the unsteered light contribution to the illumination would be too much non-uniform, but also that the unsteered image cannot be too large so that too much unsteered light falls next to the target image and will thus be lost.

This means that the unsteered image is preferably small, so that too much of side areas and corner areas are under-illuminated, but also that the unsteered image is preferably too large so that too much unsteered light falls next to the target image and will thus be lost.

As a result of this construction of a highlighter light beam converging from the relevant SPM to the first target image, the spatial phase modulator is no longer illuminated with a flat wavefront for the whole spatial phase modulator, but with a curved wavefront which will maintain the possibility to steer the beam inside of the first target image, actually with a better steering efficiency towards that smaller target image than for the case that a parallel illumination would be used from the SPM to the first intermediate target image.

If the shape of the unsteered light image is smaller than the steered image, there will be an unsteered illumination spot smaller than the imager which causes a clearly delimited extra illumination zone which will be noticeable in the final image. If the unsteered light illumination image is larger than the steered image relayed to the imager, than a part of the illumination light is not used to contribute to the “baseline” illumination which is leading to less light output.

In this embodiment, the converging illumination also increases the efficiency of a spatial phase modulator provided for the steering of the light, because the steered light is already directed towards the smaller target image, and the grating that controls the specific steering is helped with that extra standard redirection towards the inside of the target image dimensions, and will thus become more efficient.

If the grating is calculated by using a method like the Gerschberg-Saxton algorithm that calculates the gratings for steering to a target at infinity, then the highlighter light beam steering can be focused at the location of the first intermediate target, e.g. by adding a Fresnel lens type phase grating—also called a “Software Lens”—to the resulting phase grating from the Gerschberg-Saxton (or other) algorithm, with a focal length equal to the distance from the spatial phase modulator to the first intermediate target image, multiplied by the ratio between the spatial phase modulator size and the first target image size (i.e. along a diagonal in each case). This focal length for this software lens is exactly the same as when the first target image would have the same size as the spatial phase modulator, thus the necessary phase grating on the spatial phase modulator(s) will have the same complexity and efficiency as for that prior art case of having a same size of the (active area of the) spatial phase modulator and the first intermediate target image, and a parallel illumination of the spatial light modulator.

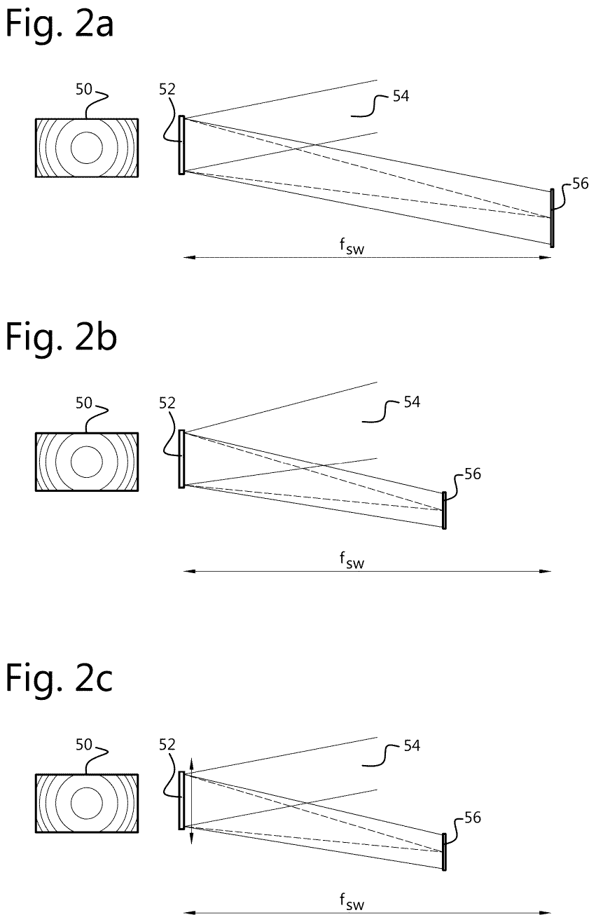

FIGS. 2a to 2c show a reflective phase modulator, e.g. piston-based spatial phase modulator. This needs a small angle between incoming and outgoing light, for keeping the two optical parts separated. This is depicted in a much exaggerated way in these drawings because the distance to the target is typically much longer than drawn here. Also, the angle can only be made in vertical direction or horizontal direction alone, so not in the direction shown on the drawings.

FIGS. 2a and 2b illustrate that there is no impact when changing from a first situation where the active area of the spatial phase modulator has the same size of the first intermediate target image and where the spatial phase modulator is illuminated by a parallel beam, to the new situation with embodiments of the present invention where the first target image size is smaller than the active area of the spatial phase modulator in the same path and the spatial phase modulator is illuminated with a converging beam, on the way the phase gratings have to be calculated and the way a software lens phase grating is added to the phase grating result.

FIG. 2a shows a (reflective) spatial phase modulator illuminated by a collimated parallel beam reflecting the specular “unsteered” light to a target image of the same size and having a phase grating called a software lens with a focal length f_{SW} that steers the incoming light to a single central point in the target image. FIG. 2b shows the same (reflective) spatial phase modulator with converging illumination reflecting the specular reflected “unsteered” light to a smaller target image, for which it can be proven that the same software lens grating with the same focal length f_{SW} will now steer the light to the central point of the smaller target at smaller distance.

FIG. 2a shows a practical arrangement of the calculation of the phase grating 50 on the spatial phase modulator 52, e.g. piston-based spatial phase modulator, in order to steer light to a target 56 of the same size at a certain distance. FIG. 2a shows a (e.g. reflective) spatial phase modulator 52 illuminated by a collimated parallel beam reflecting the specular reflected “unsteered” light to a target image 56 of the same size, and having a phase grating called a software lens 50 with a focal length f_{SW} that steers the incoming light 54 to a single central point in the target image 56. The calculation can, for instance, use the Gerschberg-Saxton algorithm that outputs the phase grating realising an angular profile of the beam steering at infinite distance. For bringing that angular beam steering profile as an illumination image at the target image 56 at the target distance, a software lens has to be added (superimposed) to the phase grating. The “software lens” 50 is a specific grating with concentric rings of phase values that resembles a “Fresnel lens” and which steers a parallel beam of light to the focus point of that Fresnel lens. If the target image 56 has a single highlight in the center of the target image 56, the outcome of the GS-algorithm will be theoretically a flat grating with a constant phase value over the whole spatial light modulator 52, producing a parallel beam, and the superimposed software lens 50 will then per definition concentrate all that on the central point in the target 56.

FIG. 2b shows the case of the converging illumination on the spatial light modulator 52 (e.g. piston-based spatial phase modulator) that makes the specular reflected beam converge to the smaller sized first intermediate target image at the distance to the first intermediate target image 56. FIG. 2b shows the same (reflective) spatial phase modulator 52 with converging illumination reflecting the specular reflected “unsteered” light to a smaller target image, for which it can be proven that the same software lens grating with the same focal length f_{SW} will now steer the light to the central point of the smaller target image 56 at a smaller distance. FIG. 2b illustrates that in this case the algorithm for the calculation of phase grating can be exactly the same as the previous case, and that, for instance, the software lens 50 superimposed on the GS-algorithm result can be configured with exactly the same focus distance f_{SW} as above, so that it does not need a stronger prescription leading to higher spatial frequency grating components that typically cause lower steering efficiency. The value for f_{SW} is now different from the real distance to the first target image 56 but has to remain equal to the distance of the target image 56 (in FIG. 2a) where it has the same size as the active area of the spatial phase modulator 52.

FIG. 2c shows another way of realizing the converging of the beam from the size of the SPM to the smaller target by providing a positive (convex) lens just in front of the SPM 52, e.g. piston-based spatial phase modulator. In the FIG. 2c, this lens is indicated by the double-arrowed line next to the SPM 52. This is the optical symbol for convex lens.

The target image 56 in FIGS. 2a, 2b and 2c does not have the same size nor being placed at the same location.

It is less preferred, compared with designing in this convergence already in the relay from fiber to SPM 52, because practically there is always a distance needed from that lens to the SPM's active surface, while for best optical performance the lens should coincide with that SPM's surface—see FIG. 2c. It is another way of doing the same job.

In this embodiment, a converging illumination can be applied by designing an optical relay that images the typically diverging, but telecentric beam from the exit of an integrator such as a fiber, preferably a rectangular fiber, to the spatial phase modulator but with the specific feature that the beam is converging so that it matches the chosen target image size. —Matching means that unsteered light is landing on the first target image in such a way that at least 85% of the target image field is illuminated with at least 75% of the light intensity of the unsteered light that is incident at the center of the first intermediate target image. Preferably at least 85% of the complete flux of unsteered light is falling within the first intermediate target image area.

The light from an integrator such as a fiber is not necessarily 100% telecentric (=having a parallel axis of the emission cone in every point on the exit surface of the fiber). It is sufficient if the optical components make a converging illumination onto the SPM. Telecentricity can be assumed or considered just for easily deriving the theoretical formulas on how to make the converging illumination. An optical relay design can be prepared to realize the desired converging illumination on the SPM from the starting condition at the exit of the optical fiber.

The converging focus length for that highlighter light beam (i.e. the distance it takes to have the converging beam from the SPM get converged into a point) is thus substantially equal to f_{conv}=D·w_{PM}/(W_{PM}−w_{TI}) where w_{PM} is the width of the active area of the spatial phase modulator, and D is the distance between the spatial phase modulator and the first intermediate target image, and W_{TI} is the width of the first intermediate target image. This is a “soft” target value and it is possible to deviate a bit from that value i.e. to make the illuminated area in the first intermediate target image a bit larger, which would only cost a bit of general light output and steering efficiency, which is suboptimal but would still work in general. That is, the convergence can still be 5%, 10% or 15% different from the optimal target value to still be part of this embodiment. The criterium to follow for the amount of convergence is the same criterium for the unsteered light beam at the first target location. This spot may not be too small because this leads to a non-uniform contribution, and may not be too big because this leads to loss of light and loss of steering efficiency.

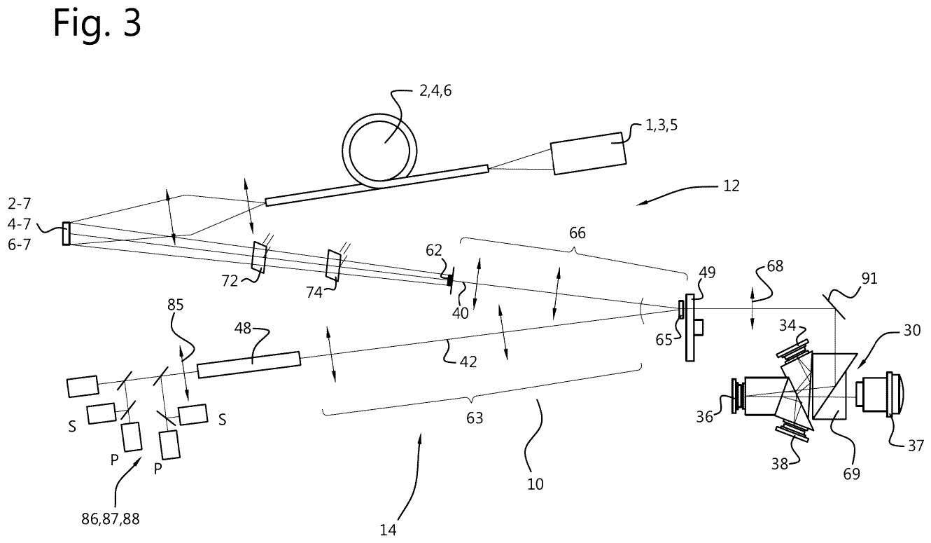

FIG. 3 shows a first embodiment of the present invention of a multicolour projector 10. The baseline optical path 14 starts with multicoloured polarised or unpolarised laser sources 86, 87, 88 e.g. for red, green and blue light, respectively producing a baseline light beam 42. These coloured beams can have dominant wavelengths of 639, 530, and 465 nm, for example, respectively for red, green and blue. Optics 85, shown as double arrowed lines in front of multi-coloured polarised laser sources 86, 87, 88, can comprise a lens or lenses, focuses the light emitted from a fiber into one or more homogenizers such as one or more light rods 48. One small rod is sufficient. The optics 85 can be a lens hat focuses the light such as the laser light into the one or more integrators like homogenizers such as one or more light rods 45, 48. A hollow rod is not required in this case, as there is no need to preserve polarization of a baseline light and there is no need for a combination method using polarization rather than angular combination which is what is used in embodiments of the present invention. One or more diffusers 82, 84 can be placed at the entrance and/or the exit of the one or more integrators such as homogenizers such as one or more light rods 45, 48, and/or in between sequential integrators or homogenizers such as light rods if present, in order to improve the spatial and angular homogenisation of the light. The light beam 42 exiting the integrator like the homogenizer or hollow rod 48 is combined with the highlighter beam 40 in a combiner before it reaches diffuser 49. In this case of an angular combination of highlighter and baseline light beams, the “combiner” does not need to be “a device” or “physical component” and, hence, this is not shown in FIG. 3. The highlighter and baseline beams can be just provided with an angle between them and they then hit a common diffuser 49 at—or close to—the “combination target plane” 65 so that all the angles get spread-out and mixed. Relay optics 63 relays the baseline beam 42 from the integrator or homogenizer such as light rod 48 to the target plane 65 and diffuser 49. The illumination spot/image at the second (combination) target plane 65 is then relayed onto the imagers such as DLPs 34, 36, 38 of the imaging engine 30 and from there to the projection lens 37 via a prism such as a TIR prism 69.

The optical path 12 of the highlighter illumination path 14 starts with light sources such as lasers, e.g. Laser Diode Aggregated (LDA) light sources 1, 3, 5, e.g. of different colours such as red, green and blue. These coloured beams can have dominant wavelengths of 639, 530, and 465 nm, for example. The light sources 1, 3, 5 couple their respective coloured light into a respective integrator or means for homogenization such as optical fibers, 2, 4, 6. The output of each integrator or means for homogenization such as optical fiber 2, 4, 6 is imaged with a converging illumination onto a spatial phase modulator per colour, 2-7, 4-7, 6-7, e.g. a piston-based spatial phase modulator. The steered highlighter light beam 40 is combined with the baseline beam 42 in angular space and relayed to an illumination profile at a plane before the imaging engine 30 comprising imagers such as DLPs 34, 36 and 38 and from there to a projection lens 37 via a prism such as a TIR prism 69.

In the drawing of FIG. 3, colour “paths” are shown as a single path with light sources, fibers and SPMs, e.g. light sources 1, 3, 5 and integrator or means for homogenization such as fibers 2,4,6 and SPMs 2-7, 4-7, 6-7, respectively. In reality, there are three separate paths, one for each colour, the first with light source 1 and integrator or means for homogenization such as fiber 2 and SPM 2-7, the second light source 3 with integrator or means for homogenization such as fiber 4 and SPM 4-7 and the third light source 5 with integrator or means for homogenization such as fiber 6 and SPM 6-7. All three paths end up on common first target image 62, actually with different distances between the SPMs 2-7, 4-7 and 6-7, e.g. piston-based spatial phase modulators and the first target image 62. For reasons of clarity, FIG. 3 shows only one path for one colour and assumes that the other paths for the other colours are coupled into that path—for instance “from the side”—at locations 72 and 74 which denote combiners such as dichroic mirrors.

An alternative embodiment includes the one shown in FIG. 3 whereby the three colour highlighter light paths are only combined via mirrors such as dichroic mirrors 72, 74 located within the telecentric relay optics path 66. In that case, the dichroic mirrors 72 and 74 are positioned inside the relay optics 66, and there will be a first target image 62 per colour and, hence, three of such images 62 in total. A first dichroic mirror can combine two primary colours such as red and green beams, a second dichroic mirror then adds the third primary colour, e.g. the blue, beam to the combined red and green beams.

The light from the integrator or means for homogenization such as fibers 2, 4, 6 is collimated, and unsteered light, which is typically a substantial fraction of the incoming light, is specularly reflected and propagated further with the same degree of collimation to the target image 62.

In prior art, where the spatial phase modulators 2-7, 4-7, 6-7, are illuminated with parallel and highly collimated light, the target image 62 was chosen with the same size as the spatial phase modulator size, and the main design parameter is the distance between the two planes. The term 1X design denotes the distance at which the separation between two diffraction orders of steered light (thus excluding the specular reflected unsteered light) are separated more than the longest dimension of the spatial phase modulator 2-7, 4-7, 6-7 and the target image 62. For instance, if the largest dimension is the spatial phase modulator width, this 1× design distance becomes D_{1×}=W·p/λ, where W is the spatial phase modulator (active) width, p is the spatial phase modulator pitch and λ is the wavelength of the light. When the distance is lower than D_{1×}, there will be more than one (steered light) order in the target image, so it is recommended and preferred to take a distance much larger than 1×, also with regard to keeping a higher efficiency. In this example of a 1.5× design, the distances D_{1.5×} can be used and they will be different for every colour due to the dependence of that distance value on the wavelength. What was meant with “active”, is that it is necessary to take the dimensions of the active area of the modulator into account, not, for example, the outer dimensions of the component.

In this embodiment with the target image 62 having a smaller size than the SPM 2-7, 4-7, 6-7, the same rationale can be followed for calculating the distances like D1× and D1.5×, except that for the value W it is now the biggest dimension of the target image 62 that has to be used. This leads to smaller distances between the SPMs 2-7, 4-7, 6-7 and the first target image 62 than in case of the prior art and, hence, a more compact optical path for the highlighter light beam.

The modulated highlighter light (illumination) beam 40 can pass through the diffuser 49 after combining with baseline beam 42. In this embodiment the spatial phase modulator 2-7, 4-7, 6-7 has a diagonal size of, for example, 0.98″. The highlighter light beams 40 are reflected by the spatial phase modulator 2-7, 4-7, 6-7 to the first target (e.g. intermediate target) image 62 which has a diagonal size of, for example, 0.7″, whereby the second target image 65 after the first relay optics 66 has a diagonal size of for example 0.873″ and the modulators such as DLPs 34, 36, 38 of the imaging engine 30 have a diagonal size of for example, 1.38″. These dimensions can be used by a DLP projector design with conventional illumination and without light steering. This embodiment works for unpolarized or partially polarized light because this is what comes out of the means for homogenization such as fiber 2, 4, 6 illuminating the SPM 2-7, 4-7, 6-7, respectively.

The f_{conv} for the converging illumination onto the spatial phase modulator 2-7, 4-7, 6-7 is thus in this case equal to, for example 398 mm×22.12/(22.12−19.56)=1342 mm, for blue.

In this embodiment, it is very advantageous to make the angular spread for a certain design factor as small as possible, so that the angular footprint of both the highlighter (illumination) light beam 40 image and the baseline (illumination) light beam 42 image are minimal, so that their joined angular footprint is also minimal and there is a lot of angular room for the diffuser 49 to spread out the light inside of the acceptance angle of the imaging engine. For example, in this embodiment the diffusor 49 can be located in or at the second intermediate image 65. This can spread the light further in angle to fill as much as possible the available imaging engine aperture.

For this reason it is an advantageous step in this embodiment to implement relay optics 66 between the first target image 62 and the second intermediate image 65 that makes the beam “quasi-telecentric” when it hits the combination image just before the diffuser 49. Quasi means here “as much as possible” and it should be optimized for the color sub-beam which has the largest angular spread at this point, which is typically the red sub-beam because of the smaller distance between SPM 6-7 e.g. piston-based spatial phase modulator and target image 62. The benefit for having the best possible telecentricity, is that the angular spread of the beam will be minimum, so that angle difference between the chief rays of the highlighter beam and baseline beam at the combination place can be kept as minimal as possible, which then leaves a maximum amount for diffusing the light without making too high angles that will not be accepted by the imaging engine 30.

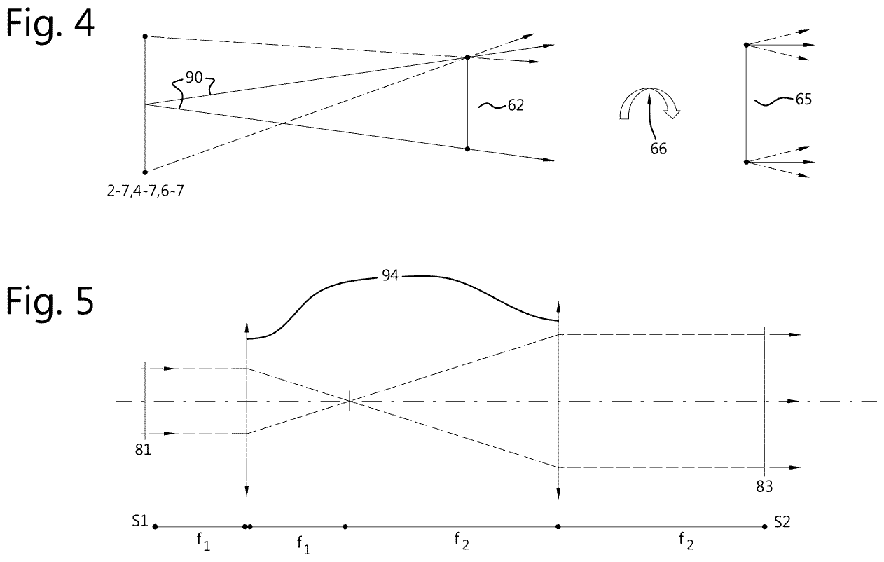

FIGS. 4, 5, 6 and 7 show various ways the relay optics 66 can be implemented between the first target image 62 and the second target image 65. Any of these designs may be used for the relay optics 66 of any embodiment. For each of these figures the first intermediate target image 62 will be located on the left side of the figure and the second intermediate target image 65 on the right side.

FIG. 4 illustrates the principle of the relay optics 66 between 1^{st} and 2^{nd} target images 62, 65, respectively that makes a telecentric beam at the 2^{nd} intermediate image 65. FIG. 4 shows how these relay optics 66 work. The rays 90 of the highlighter beam from the center of a spatial phase modulator 2-7, 4-7, 6-7 e.g. piston-based spatial phase modulator, falling on all the locations on the first target image 62 have to be made parallel in the 2^{nd} intermediate image 65, especially the ones at the edge of the first intermediate image 62. The relay optics 66 between 1^{st} and 2^{nd} intermediate images 62, 65 makes a telecentric beam at the 2^{nd} intermediate image 65.

FIG. 5 shows an example implementation of relay optics 66 from a telecentric beam 81 to a telecentric beam 83 with different size, e.g. in this case the beam 83 has a larger diameter.

This function of relay optics 66 can, for instance, be realized with a simple two-lens group relay design with some specific adaptation. An input telecentric beam 81 can be converted to a magnified telecentric beam 83 by a two-lens group arrangement 94, as shown in FIG. 5, with focal lengths f1 and f2 where the magnification is then defined by f2/f1.

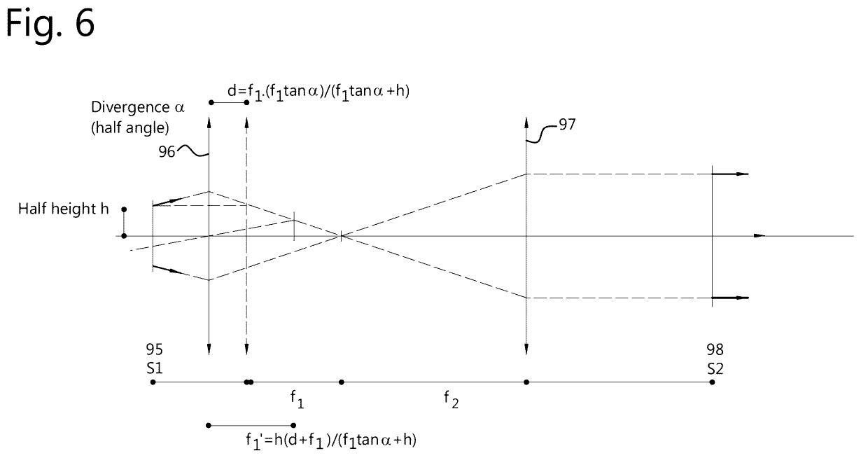

If the highlighter light beam 95 at S1 is diverging as in FIG. 6, this design can be modified via a repositioning of the first lens 96 (focal length f1) towards the 1^{st} intermediate target image 62, namely this to the left side, and a modification of the focal length to f1′. The total distance span to the relay optics 66 doesn't need to change, however. The implementation of relay optics 66 from a non-telecentric beam 95 to a telecentric beam 98 with different size, by changing position and prescription of one of the two lenses 96, 97 is shown in FIG. 6.

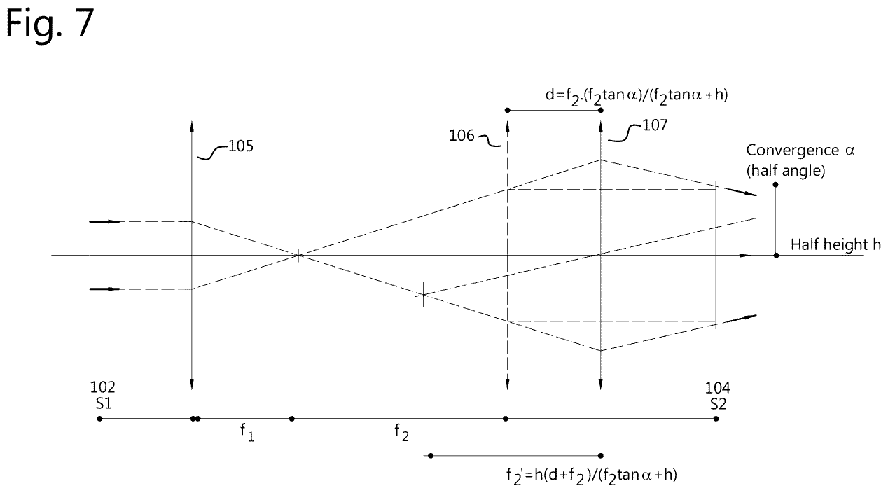

In one of the methods for making a converging illumination at the spatial phase modulator 2-7, 4-7, 6-7, e.g. piston-based spatial phase modulator, the same principle can be used for a similar relay optics from the exit of the integrator or homogenization rod or fiber 2, 4, 6 to the spatial phase modulator 2-7, 4-7, 6-7, now by shifting the second lens 106 in the relay optics 105 (lens), 106 (lens), 107 (lens), as shown in FIG. 7. FIG. 7 is similar to FIG. 6, but the relay optics 66 extends from a telecentric beam 102 to a non-telecentric (converging) beam 104.

If a fiber is used the ratio between f2/f1 can become quite high, i.e. for a magnification of 70×.

The main advantage of the smaller intermediate target image 62 is that the optical path from the spatial phase modulators 2-7, 4-7, 6-7 to the second intermediate image 65 can be made more compact, in both of the highlighter and baseline optical paths 12, 14, without any impact on the size of the smallest possible illumination spot of the imaging engine 30, and without any impact on the angular spread of the highlight light beam 40 at the second intermediate image spot 65.

The following table 2 shows non-limiting examples of the changes in path lengths for the design with different sizes for the 1^{st} target image 62 for the blue path (dominant wavelength 465 nm). D1.1× is the distance between the spatial phase modulator 2-7, 4-7, 6-7 and the first intermediate image 62, D2PM is the distance from exit of the integrator or means for homogenizing such as fibers 2, 4, 6 (in this case) to the spatial Phase Modulator 2-7, 4-7, 6-7 and D2TI2 is the distance between the first target image 62 and the second target image 65 aka intermediate image. It is clear that the reduction of the 1^{st} target size produces a large reduction in the optical path length from the spatial phase modulator 2-7, 4-7, 6-7 e.g. piston-based spatial phase modulator, to the second intermediate image 65, and that without big changes in the location and dimensions or feasibility of the optical components.

TABLE 2

| 1^{st} | | Focal for | | | | | | Total |
|---|---|---|---|---|---|---|---|---|
| target | | converging | | Relay2T1 | | Relay2T2 | | Path |
| size | D1.1x | illumination | | f1; f2; f2′; d | D2PM | f1; f1′; f2; d | D2TI2 | length |
| 0.98″ | 565 mm | Infinity | | f1 = 1.5 mm | 213 mm | f1 = 56 mm | 212 mm | 990 mm |
| | | | | f2 = 105 mm | | f2 = 50 mm | | |
| | | | | d = 0 mm | | and if * | | |
| | | | | | | f1′ = 55.5 mm | | |
| | | | | | | d = 5.1 mm | | |
| 0.7″ | 398 mm | 1342 | mm | f1 = 1.5 mm | 213 mm | f1 = 40.1 mm | 180 mm | 791 mm |
| | | | | f2 = 105 mm | | f1′ = 39.8 mm | | |
| | | | | f2′ = 104.5 mm | | f2 = 50 mm | | |
| | | | | d2 = 7.6 mm | | d1 = 3.7 mm | | |
| 0.49″ | 282 mm | 565 | mm | f1 = 1.5 mm | 213 mm | f1 = 28.1 mm | 156 mm | 651 mm |
| | | | | f2 = 105 mm | | f1′ = 27.9 mm | | |
| | | | | f2′ = 102.4 mm | | f2 = 50 mm | | |
| | | | | d2 = 16.5 mm | | d1 = 2.5 mm | | |

* if telecentric correction is used for the beam in the 2^{nd} intermediate image

If the optical relay 66 is created as indicated above and shown in FIG. 3, the angular distribution of the light at the 2^{nd} intermediate image 65 is well determined. In the angular space, the spread will take the form of a rectangle, with an angular width given—in paraxial approximation—by w_{PM}/D/M, with w_{PM} being the width of the relevant spatial phase modulator 2-7, 4-7, 6-7. D is the distance between the spatial phase modulator 2-7, 4-7, 6-7 and the first target image 62. M is the spatial magnification factor between the first and second intermediate images 62, 65. The same is true for the angular height with, in this case, the spatial phase modulator height h_{PM} replacing w_{PM} in the formula.

These are the angular width and height values for the light coming out of the 2^{nd} intermediate image 65 for the example given above, when the 1^{st} target 62 has an image diagonal size of 0.7″ (and actually the result is independent of that value):
Size of 2^{nd} intermediate image 65 (0.87″) 19.56 mm×10.46 mm
Angular spread at 2^{nd} intermediate image, if the relay brings it back to telecentricity, in horizontal direction:
   Red: 60.9 mrad or 3.5°
   Green: 50.5 mrad or 2.9°
   Blue: 43.9 mrad or 2.5°
Vertical direction:
   Red: 32.1 mrad or 1.8°
   Green: 26.6 mrad or 1.5°
   Blue: 23.3 mrad or 1.3°

These angular spread values are typically much smaller than the angle accepted by the projector's imager system (imaging engine 30). If the beam with the dimensions from the example above is used to illuminate a red, a green and a blue 1.38″ DLP imager using a projection lens 37 with F/4.5, then the acceptance angle of that imaging engine 30 in the input plane of 0.87″ would be a solid angle formed by a circle in angular space with a diameter of about 20°.

The baseline beam 42 should also illuminate a same size spot of the second intermediate image 65, and if the angular spread of the baseline illumination has substantially the same or similar extent as the angular spread of the highlight beam 40, it is possible to combine the two highlighter and baseline light beams with only a small angular gap in between, so it is possible to deliver these two beams at a close enough distance that there is enough room for the extra angle spreading action of a diffuser 49 inside the acceptance angle of the imaging engine 30 and projection lens 37, which is useful for de-speckling and radiance reduction.

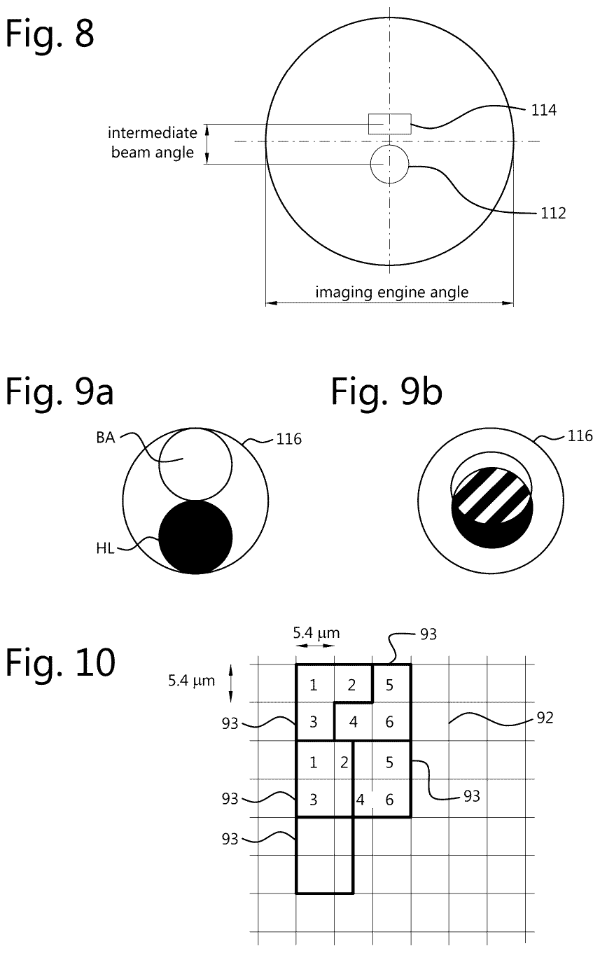

FIG. 8 shows the situation after combining the highlighter light beam 114 and baseline light beam 112 in angular space at the 2^{nd} intermediary image 65, before the diffusive action of diffuser 49 is performed.

FIG. 9a shows the angular space taken by the conventional highlighter light beam and baseline light beam, each having a diameter half the size of the diameter corresponding to the acceptance angle 116 of the imaging engine. FIG. 9b shows the situation in accordance with the present invention, showing the angular space after the combined beam has been transmitted through the diffuser 49, a situation which will be found back—at a different scale—in the exit pupil of the projection lens 37. FIG. 9b shows an angular spread of the combined baseline beam and highlighter beam after the diffuser 49, as also visible in the exit pupil if one would hypothetically look into the projection lens 37.

In this configuration, the diffuser 49 just spreads angles over a certain angular distance, so that the diffusive power can be optimized to extend just to the edge of the acceptance angle of the imager (so no light is lost), thereby maximizing the de-speckling functionality and maximizing the reduction of the maximum radiance when looking into the exit pupil, which is key for reducing the laser safety hazard risk of the projector (e.g. the requirements of IEC60825-1 and IEC62471-5 can be met). Also, there is no light loss by light being diffused outside of the acceptance angle.

The highlighter light beam and the baseline light beam will also share an angular overlap which will also be beneficial for the spatial uniformity of the final image (i.e. no specific vignetting on only one of the highlighter or baseline illumination).

With reference to derivation of a formula for PSF and angular spread, it has also been proven generically that by following the teachings of this embodiment, and in case of assuming the ideal optical systems for all the necessary illumination and imaging relays, thus assuming no optical aberrations and defocusings, the (theoretical) value for the PSF or point spread function of the highlighter (illumination) light beam on the imaging engine 30, expressed as a percentage of the imager width or thus projected image width, can be given by the following formula:

$$PSF ( \% ) = 2 {NA}_{fib} * {W}_{fib} / λ * DF / HRES + Δ {PSF ( \% )}_{opt}$$

This formula is independent of the sizes of the first and second intermediate images in the highlighter optical path and depends only on the (used) NA and width W of the fiber between light source 1, 3, 5 and spatial phase modulator 2-7, 4-7, 6-7, the design factor (DF) and the horizontal number of pixels of the spatial phase modulator (HRES) 2-7, 4-7, 6-7. The extra DPSF term in this equation stands for potential extra blurring of the highlighter PSF due to aberrations and defocusing in the complete optical path.

In case of the chosen example in this embodiment, e.g. with a 0.98″ spatial phase modulator (SPM phase modulator), this will yield a spread of the highlight illumination versus the imager width equal to PSF=13.7% for this case of a 0.98″ spatial phase modulator 2-7, 4-7, 6-7 with 10.8×10.8 um pixels. This is with the following input values for this example:
Wavelength: 525 nm
Fiber: 355×187 micron (355 micron used for the calculation)
NA fiber: 0.19
Design Factor: 1.1×
Extra PSF from extra optical blurring is neglected: 0%

This is a workable number for a beam steering HDR (High Dynamic Range) projector architecture.

Advantages of this embodiment include that the complete highlighter optical path 12 can be made shorter, more compact and, thus, less expensive, and without any fundamental reduction in performance, by making the size (e.g. diagonal) of the first intermediate image 62 smaller than the active area of the spatial phase modulator 2-7, 4-7, 6-7 (e.g. diagonal), making a converging illumination matched to the size difference so that the specular reflected light (which is unsteered light) substantially maps with that smaller size image at the 1^{st} target plane. Matching means that unsteered light is landing on the first target image in such a way that at least 85% of the target image field is illuminated with at least 75% of the light intensity of the unsteered light that is incident at the center of the first intermediate target image. Preferably at least 85% of the complete flux of unsteered light is falling within the first intermediate target image area.

Another generic formula can be derived for the angular spread of the highlighter light beam in the 2^{nd} intermediate image 65 or on the final imager 30 (thus after the relay that makes the beam telecentric), with W_{img} being the image at the examined image location (i.e. intermediate image 62 or imaging engine 30), HRES again the horizontal resolution and DF is a design factor:

$$Ang\_H = λ / {W}_{img} * HRES / DF$$

A second advantage of this embodiment is that, by adding relay optics 66 from the first target image 62 to the second target image 65 or to the imaging engine 30, that makes the diverging steered beam in the highlighter optical path telecentric, one can create a minimum envelope size of the angular spread for the complete beam in that second intermediate image 65 so that a combination of the baseline and the highlighter light beams 40, 42 by angle can be performed with a baseline (illumination) light beam 42 being designed to be confined to a similar sized angular spread, before the combined beam hits a common diffuser 49 that performs a further spreading of the light in the angular space in order to perform maximum laser de-speckling and exit pupil radiance reduction.

The embodiment provides a compact highlighter optical path and also a method of implementing a compact highlighter light path and also provides steered light with a minimum angular footprint (because of having a telecentric beam) at the location of combination of the highlighter light beam with the baseline light beam and before reaching the angle spreading diffuser 49. This can be realized with the following steps, per color:

A highlight light beam is made by:
A laser source providing light to an integrator or a means for homogenization such as a fiber with small enough dimensions so that it creates a highly collimated beam (i.e. with a Beam Parameter Product of less than 50 mm·mrad)
A relay optical system from the integrator or means for homogenization such as the fiber 2, 4, 6 to the spatial phase modulator 2-7, 4-7, 6-7, e.g. piston-based spatial phase modulator, respectively that realizes a converging illumination on the active spatial phase modulator area
A spatial phase modulator 2-7, 4-7, 6-7 per color, e.g. a piston-based spatial phase modulator per colour
A first intermediate target image 62 substantially smaller than the active area of the spatial phase modulator 2-7, 4-7, 6-7 (SPM e.g. piston-based spatial phase modulator) (i.e. more than 15% smaller) and the convergent illumination realized in such a way that the specular reflected beam (which is unsteered light) substantially matches with that first intermediate target size. Matching means that unsteered light is landing on the first intermediate target image in such a way that at least 85% of the target image field is illuminated with at least 75% of the light intensity of the unsteered light that is incident at the center of the first intermediate target image. Preferably at least 85% of the complete flux of unsteered light is falling within the first intermediate target image area.
A second relay optical system 66 that images the 1^{st} intermediate image 62 on a 2^{nd} intermediate image 65 and where the beam is made telecentric.

Also a beam combination system and method are provided in this embodiment that combines the three coloured highlight beams 12 via a set of two colour combiners 72, 74, such as 2 dichroic mirrors placed in the optical path per color between the spatial phase modulator 2-7, 4-7, 6-7 of that color and a common 2^{nd} intermediate image 65, in such a way that the three colour highlighter light beams share the same optical axis when arriving at that second intermediate image 65. A first dichroic mirror can combine two primary colours such as red and green beams, a second dichroic mirror then adds the third primary colour e.g. the blue beam to the combined red and green beams.

Also a baseline light beam and method are generated from an aggregation of light sources 86, 87, 88 such as collimated light sources such as lasers or laser diodes with wavelengths in each of the primary colors. These coloured beams can have dominant wavelengths of 639, 530, and 465 nm, for example. All beams are collected into an integrator or a homogenization optics such as a rod 48 delivering a combined beam with an etendue similar to the etendue of the highlighter light beam at the 2^{nd} intermediate image 65, and smaller than i.e. ⅛^{th} of the etendue of the imaging engine 30 having projection lens 37. The collimation degree of light sources 86-88 for the baseline light beam can be lower than that for the highlighter light beam. The light of baseliner light sources 86-88 has to fit into a small rod such as a 1-2 mm rod, whereas the light from light sources 1, 3, 5 for the highlighter beam has to fit into a much smaller fiber which functions as an integrator or a means for homogenization.

Also an angular beam combination system and method are provided, where the baseline light beam 42 and highlighter light beam 40 share a same size on the intermediate image 65, and where the highlighter light and baseline light beams 40, 42 are combined via a small inter-beam angle. This can be smaller than two times the angular dimensions of the individual highlighter and baseline light beams 40, 42.

Also a diffuser 49 is provided after the intermediate image 65 spreading the angles at the plane of the intermediate image 65 in such a way that the beam spread is optimized up to the angular limits accepted by the imaging engine 30 having projection lens 37.

In a further embodiment of this invention, the spatial phase modulator 2-7, 4-7, 6-7, e.g. piston-based spatial phase modulator, is chosen to have a pixel aspect ratio different from 1, but also different from 1 over the aspect ratio as claimed in GB2551870 (Daqri), for the reason of implementing this with a piston-based spatial phase modulator whereby an example is provided in US2019/179134 which is incorporated herewith by reference.

All the embodiments can utilize piston-based spatial phase modulators e.g. for the modulators 2-7, 4-7, 6-7 of FIG. 3 or the modulators 2-7, 4-7, 6-7, 2-8, 4-8, 6-8 of FIG. 1. In the specific case of the piston-based spatial phase modulator, the piston-pixels are built up by combining a set of electrodes that are made in a square form. The typical piston form has a size of 2×2 square pixels. In that case, each “piston” or spatial phase modulator pixel can be driven via four electrodes that can deliver sixteen different piston positions (=retardations). It has been verified that this is sufficient for beam steering purposes. The invention is not limited to 16 retardation levels.

In this further embodiment, a specific piston electrode shape of a piston-based spatial phase modulator is used that is based on a number of (e.g. three) square-pitch placed electrodes, that would drive a piston-pixel aspect ratio of 3:4, with 3 in the direction of the device's width, and 4 in the direction of the device's height.

FIG. 10 shows a square raster or grid which denotes the electrode pixel structure (with 5.4 micron pitch, for example). The piston-based pixel 93 is moved by electrodes 92 and is, for example, square or rectangular, such as 10.8 micron high and 8.1 micron wide, and can be driven with three of the 5.4 micron pitch electrodes 92 (e.g. square), thus with 3-bit or 8 retardation levels. It has been verified that this is a sufficient number of retardation values for a beam steering application. These devices are not limited to eight retardation levels but can have sixteen or a higher number of retardation levels.

In this embodiment, the pixels of the spatial phase modulator especially a piston-based pixel type with an asymmetric or non-square pixel aspect ratio such as a 3:4 aspect ratio. This can used for the piston-based phase modulator pixel size in combination with a typical projector imager aspect ratio such as 16:9, or 16:10 or 1.896:1 as used in Cinema projectors (i.e. 4096×2160 pixels).

This embodiment does not claim the construction of such a 3:4 piston-pixel based spatial phase modulator device itself. This embodiment claims the combination of a spatial phase modulator device and an imager device of which the aspect ratios substantially (i.e. >10%) deviate from being inversely proportional.

This further embodiment uses a spatial phase modulator with pixels having a non-square aspect ratio of 3:4 in order to make the optical path more compact. Because of the smaller pitch in the horizontal direction, the beam steering angles can be made larger in that direction, and, therefore, the design distance from the spatial phase modulator to the first intermediate target image 62, that is necessary to keep all other steered diffraction orders out of the first target image 62, can be smaller.

A spatial phase modulator (SPM) such as a 0.98″ spatial phase modulator (SPM) with such pixels with 3:4 aspect ratio (8.1×10.8 um) would thus have 3072 pixels horizontally and 1080 pixels vertically.

In case of using a 3:4 aspect ratio on the 0.98″ spatial phase modulator (pixels 8.1×10.8 micron) like the previous example, this means that a distance between spatial phase modulator and 1^{st} intermediate target image 62 can be reduced as well.

In the case of a 1^{st} intermediate target image size=0.7″ and if the 1.1× design factor is maintained, the distances can be as follows:
Red: 217 mm
Green: 262 mm
Blue: 298 mm

Because of this shorter distance, the converging illumination onto the spatial phase modulator is more pronounced, leading to a focal length for this converging illumination of 1005 mm for blue (instead of 1340 mm in case of the 10.8×10.8 um pixel size). In the case of using the same kind of 2-lens relay designs as in FIGS. 5, 6 and 7, the full distances of the relays optics from the integrator or means for homogenization such as a fiber to the spatial phase modulator and from the 1^{st} intermediate target image 62 to the second intermediate image 65 can be kept as well. However, because of the higher converging angles of the spatial phase modulator illuminating beam (i.e. the highlighter light beam) and the higher diverging angle on the first intermediate target image, some lens position shift and focal length modifications have to be made.

The first lens 1 of the relay optics 66 which extend from the 1^{st} intermediate target image 62 to 2^{nd} intermediate target image 65 in the previous example should be shifted more towards the 1^{st} intermediate target image 62 (4.8 mm instead of 3.7 mm) and the focal length has to be adapted a little more (35.3 mm instead of 36.4 mm)—this is again for the example of blue and a 0.7″ first target image size. This is one example of how to adapt a relay optics, but other methods are possible.

In the calculation of the phase grating for the spatial phase modulator, again a software-lens is added to the grating calculated for a steering target at infinity, with a focal length determined by the new distance between the spatial phase modulator and the first target image 62, multiplied by the ratio of the spatial phase modulator size (i.e. width, or diagonal, height) over the 1^{st} target image size (i.e. width, or diagonal, height).

The total length of the blue highlighter light path for the example of a 0.7″ target image size is hence reduced with 100 mm (398 mm→298 mm) from 791 mm to 691 mm.

Also because of the shorter distance from the spatial phase modulator to the 1^{st} intermediate target image 62, the PSF of the final solution is reduced, which will enable a higher highlighting peak factor in the image, and an advantageous improvement of the beam steering system. The PSF can become 10.3% (instead of 13.7% with 10.8×10.8 um pixels).

The angular spread of the highlighter light beam will increase with a factor 1.33× but this can still be accommodated, i.e. with a weaker diffuser.

This further embodiment has the same advantages as the first embodiment plus the following:

Use of at least one spatial phase modulator per color with an aspect ratio different from 1 over the aspect ratio of the imager, for example a square electrode based piston-based pixel spatial phase modulator with pixels with an aspect ratio of 3:4 can be used, for an imager with an aspect ratio substantially higher than 1.33:1, i.e. 16:9, 16:10 or 1.896:1 like used for cinema projectors with 4096×2160 or 2048×1080 resolution).

In a further embodiment of the present invention the optical relay 66 from the 1^{st} intermediate target image 62 to the 2^{nd} intermediate target image 65 in the highlighter optical path 40 is omitted. Other elements ramin the same as in the second embodiment. The result is that the highlighter light beam is no longer made telecentric, and that the angular footprint of that highlighter light beam 40 at the plane of combination with the baseline light beam 42 will become larger than for the system with the extra optical relay 66 described in the previous embodiment(s). This will create less room to perform a diffusion function afterwards for de-speckling and can cause more residual speckle in the image. But on the other hand, avoiding relay optics 66 will make the solution more compact and less costly.

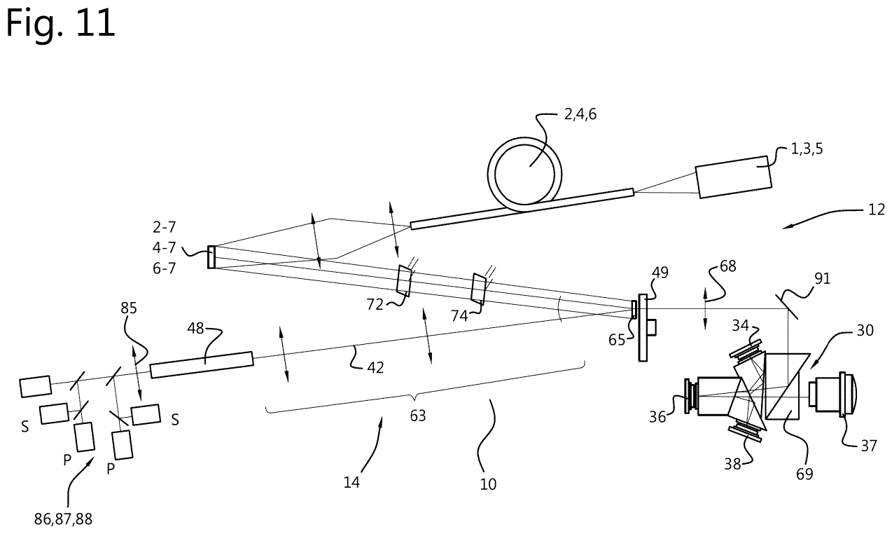

FIG. 11 shows a schematic projector system for this embodiment with a direct and non-telecentric steering of the highlighter (illumination) light beam, with some example dimensions of components and images as illumination system for a 3-chip 1.38″ DLP imaging engine 30. The baseline optical path 14 starts with multicoloured polarised laser sources 86, 87, 88 e.g. for red, green and blue light, respectively producing a baseline light beam 42 with different polarizations. These coloured beams can have dominant wavelengths of 639, 530, and 465 nm, for example. Optics 85 focuses the light emitted from the light sources into one or more integrators such as homogenizers such as a solid or hollow light rod 48. One or more diffusers (not shown) can be placed before and/or after the integrator or homogenizer such as the hollow or solid rod 48. The baseline light beam 42 exiting the integrator or homogenizer such as the hollow or solid rod 48 is relayed via relay optics 63 and the emerging beam 42 is combined with the highlighter light beam 40 e.g. in a combiner. Relay optics 63 guides the light exiting the integrator or the homogenizer such as hollow or solid rod 48 to the combiner and from there through a diffuser element 49 to a spatial light modulator or three spatial light modulators 34, 36, 38, via a Prism such as a TIR prism 69 to a projection lens 37.

This embodiment can be used for a multicolor projector architecture, e.g. for three primary colors such as red, green and blue. The path for one colour is shown in FIG. 11. The two other colors (not shown on the FIG. 11) have similar paths-however with some different distances-so that the three colors R (red), G (green), B (blue) have their own laser sources 1, 3, 5, integrator, means for homogenization such as fibers 2, 4, 6, lenses and spatial phase modulators 2-7, 4-7, 6-7 which can be piston-based spatial phase modulators. These coloured beams can have dominant wavelengths of 639, 530, and 465 nm, for example. If required, these optical elements can be with specifically tuned dimensions. In FIG. 11, colour “paths” are shown as a single path with light sources, integrator, means for homogenization such as fibers and SPMs, that is, light sources 1,3,5 and integrator or means for homogenization such as fibers 2,4,6 and spatial phase modulators 2-7, 4-7, 6-7, respectively. In reality, there are three separate paths, one for each colour, the first with light source 1 and integrator 2 and spatial phase modulator 2-7, the second light source 3 and integrator 4 and spatial light modulator 4-7 and the third with light source 5 and integrator 6 and spatial phase modulator 6-7. All three paths end up on common first intermediate target image 62, actually with different distances between the device 2-7, 4-7 and 6-7 and the first intermediate target image 62. For reasons of clarity, FIG. 11 shows only one path for one colour and assumes that the other paths for the other colours are coupled into that path—for instance “from the side”—at locations 72 and 74 which denote dichroic mirrors.

Beams from the three different paths are combined in a combiner such as dichroic mirrors at a location between the spatial phase modulator 2-7, 4-7, 6-7 and the common target image 65 at the entrance of the imaging engine 30. The three colors will have a different distance from the spatial phase modulator 2-7, 4-7, 6-7 to the common and smaller intermediate image, 65 which also means that the amount of converging illumination is also tuned per color.

FIG. 12a and FIG. 12b show examples of the angular spread of the highlighter light (illumination) beam and the baseline (illumination) light beam in the case of the first embodiment (FIG. 12a) and third (FIG. 12b) embodiment (FIG. 12b with relay 66 and FIG. 12a without relay). The first embodiment is shown in FIG. 3 and the third embodiment is shown in FIG. 11. This example is of a 3-chip 1.38″ DLP imaging engine 30. The entrance of the imaging engine 30 is shown, with in FIG. 12a the situation of the first embodiment (see FIG. 3) and in FIG. 12b the situation of the third embodiment (see FIG. 11). The aperture is 20° (f/4.5) for all examples.

For the red highlight beam HL(R), the angular spread for the red color (first embodiment: 3.49×1.84° and third embodiment: 6.57×3.49° is shown as this is the largest, whereby the green and blue highlight beam are smaller rectangles with the same center point (first embodiment green: 2.89×1.52° and third embodiment green: 5.45×2.89° first embodiment blue: 2.54×1.34° and third embodiment blue: 4.78×2.54°.

Note that in the situation of the third embodiment (third embodiment: 6.57×3.49°, shown in FIG. 12b, there is a bigger angular spread-out of the highlighter light n beam 126 compared with the baseline light beam 128, which leaves less room for the common diffuser to spread out the angles for despeckling and exit pupil radiance reduction. There is a bigger risk for residual speckle of the product in this case, so it could be applied for situations where speckle in the image and the need for a reduced radiance in the exit pupil are less critical. The baseline light beam spreading 128 is depicted as a circle which is for the first and third embodiment smaller than the spreading of the highlighter light beam.

Note: this example above is only one example limited to a specific design with 1.38″ DLP imagers. The same concept of embodiments 1, 2 or 3 (first embodiment shown in FIG. 3, third embodiment in FIG. 11, and second embodiment described in the text with reference to aspect ratios) can be constructed for illuminating other imagers such as a 3-chip 0.98″ DLP imaging engine, with the use of the same 0.98″ spatial phase modulators but with a smaller 0.57″ intermediate target image at the entrance of the imaging engine 30. Also in the case of the third embodiment the uniform and converging illumination is necessary to go from 0.98″ diagonal beams to a 0.57″ diagonal target. Other implementations with other component sizes which are different from the numeric examples given, are within the scope of the present invention.

Methods according to the present invention can be performed by a controller or control unit such as a microcontroller or a digital processing device or any similar controller or control unit either as a standalone device or embedded in a projector or as part of an optical subsystem for a projector (not shown in the Figures). The main methods controlled by a controller in accordance with any of the embodiments of the present invention can include controlling the operation of spatial phase modulators in order to create dynamically varying steered light and to control laser drivers for the light sources of both the baseline and the highlight beam. This can include reducing power or switching off the lasers if there is danger to persons near a projector according to any of the embodiments of the present invention. The present invention can use a processing engine being adapted to carry out these functions. The processing engine preferably has processing capability such as provided by one or more microprocessors, FPGA's, or a central processing unit (CPU) and/or a Graphics Processing Unit (GPU), and which is adapted to carry out the respective functions by being programmed with software, i.e. one or more computer programs. References to software can encompass any type of programs in any language executable directly or indirectly by a processor, either via a compiled or interpretative language. The implementation of any of the methods of the present invention can be performed by logic circuits, electronic hardware, processors or circuitry which can encompass any kind of logic or analog circuitry, integrated to any degree, and not limited to general purpose processors, digital signal processors, ASICs, FPGAs, discrete components or transistor logic gates and similar.

Such a controller or a processing device may have memory (such as non-transitory computer readable medium, RAM and/or ROM), an operating system, optionally a display such as a fixed format display, ports for data entry devices such as a keyboard, a pointer device such as a “mouse”, serial or parallel ports to communicate with other devices, network cards and connections to connect to any of the networks.

The software can be embodied in a computer program product adapted to carry out the functions of any of the methods of the present invention, when the software is loaded onto the controller and executed on one or more processing engines such as microprocessors, ASIC's, FPGA's etc. Hence, a processing device controller for use with any of the embodiments of the present invention can incorporate a computer system capable of running one or more computer applications in the form of computer software. The controller can comprise a digital processing device, the controller being adapted to control the operation of spatial phase modulators in a projector having a baseline light beam and a highlighter light beam, the controller being adapted to control the spatial phase modulators to generate dynamically varying steered light and optionally unsteered light from the highlighter light beam, and to control spatial light modulators to generate images for projection from a combination of the non-steered light, the steered light and the baseline light beam, the steered light creating highlights in the images.

It is intended to be understood that the following aspects further describe features of the present invention.

1. A multicolored optical assembly for providing a highlighter light beam of steered light to a first intermediate target image, comprising a baseline optical path generating a baseline light beam, the optical assembly having a highlighter optical path providing the highlighter light beam of steered light, the assembly being configured to combine the highlighter light beam of steered light with the baseline light beam to form a combined beam, wherein the multicolored optical assembly is adapted to configure the highlighter light beam by the following per color:
a multicolored laser source providing light to an integrator per colour, the integrator providing a homogenized and collimated beam for each colour,
a spatial phase modulator per color in the highlighter optical path, wherein the homogenized and collimated beam for each colour is incident upon the spatial phase modulator and is phase modulated for each colour by the spatial phase modulator, per colour, each spatial phase modulator having an active spatial phase modulator area,
means for converging steered light of the highlighter beam to be incident on a first intermediate target image,
wherein, in a first case, an illuminated area of the converged steered light illumination incident on the first intermediate target image is smaller than the active spatial phase modulator area, and/or,
   in a second case, the means for converging is configured for converging the homogenized and collimated beam for each colour onto the spatial phase modulator,
   and for both cases, the converged steered light illumination is realized in such a way that a specular beam of unsteered light of the highlighter light beam matches with a size of the first intermediate target image.

2. A multicolored optical assembly according to aspect 1, wherein for matching with a size of the first target image, the unsteered light is landing on the first intermediate target image in such a way that at least 85% of the first target image area is illuminated with at least 75% of the light intensity of the unsteered light that is incident at the center of the first intermediate target image.

3. A multicolored optical assembly according to aspect 1 or 2, wherein at least 85% of a complete flux of unsteered light is falling within the first intermediate target image area.

4. A multicolored optical assembly according to any of the previous aspects, wherein a lens is configured to converge the steered light.

5. A multicolored optical assembly according to any of the previous aspects, wherein the highlighter light beam is randomly polarized or is unpolarized.

6. A multicolored optical assembly according to any of the previous aspects, wherein the baseline light beam is constructed from beams of three primary colour light sources which share a common integrator and are combined into a white beam.

7. A multicolored optical assembly according to any of the previous aspects, wherein the highlighter light beam has an illumination profile with a first resolution, and the highlighter light beam is combined with the baseliner light beam which has an optionally rectangular illumination profile, and wherein the combined beam is relayed to imagers that make an image having a second resolution higher than the first resolution.

8. A multicolored optical assembly according to any of the previous aspects, wherein the spatial phase modulator per colour is a piston based spatial phase modulator.

9. A multicolored optical assembly according to any of the previous aspects, wherein the highlighter light beam and the baseline light beam are combined in angular space.

10. A multicolored optical assembly according to aspect 9, comprising a diffuser and wherein the combined highlighter and baseline light beams overlap in angular space after they have been combined and have passed the diffuser.

11. A multicolored optical assembly according to any of the aspects 7 to 10, wherein the highlighter light beam of steered light is combined with the baseline light beam and the highlighter light beam and baseliner light beam converge at an included acute angle.

12. A multicolored optical assembly according to any of the previous aspects, further comprising an imager, and wherein at least one diffuser is in an optical path between the first intermediate target image and the imager, and wherein the diffuser increases the angular spread of the combined beam.

13. A multicolored optical assembly according to any of the previous aspects, further comprising a relay optical system that images the first target image on a second target image and wherein the highlighter light beam is made telecentric.

14. A multicolored optical assembly according to any of the previous aspects, wherein the first target intermediate image is smaller than the active area of the spatial phase modulator by at least 5%, 10% or 15% or even smaller.

15. A multicolored optical assembly according to any of the previous aspects, wherein the integrator in the highlighter optical path is an optical fiber.

16. A multicolored optical assembly according to aspect 15, wherein the optical fiber has a Beam Parameter Product of less than 50 mm·mrad.

17. A multicolored optical assembly according to aspect 15 or 16, wherein a cross-section of a core of the optical fiber is rectangular.

18. A multicolored optical assembly according to any of the previous aspects, wherein the spatial phase modulator is illuminated by incoming light, which is the homogenized and collimated beam for each colour, and reflects specularly reflected “unsteered” light to the first intermediate target image of the same size, and wherein the spatial phase modulator is configured to steer the incoming light to a single central spot in the first intermediate target image.

19. A multicolored optical assembly according to aspect 18, wherein the incoming light is the converged highlighter light beam incident onto the spatial phase modulator and the spatial phase modulator per colour reflects the incoming light thereby providing further converging of the highlighter light beam.

20. A multicolored optical assembly according to aspect 18 or 19, comprising a convex lens in front of the spatial phase modulator configured to converge the highlighter light beam to reduce from the size of the active area of the spatial phase modulator to the size of the first intermediate target image.

21. A multicolored optical assembly according to any of the previous aspects, further comprising a beam combination system that is configured to combine three coloured baseline light beams from the baseline optical path with three coloured highlighter light beams from the highlighter optical path, and wherein the beam combination system is located between the spatial phase modulator of each colour and a second target image, in such a way that the three coloured highlighter light beams share a same highlighter optical path when arriving at a second target image.

22. A multicolored optical assembly according to aspect 21, wherein the beam combination system comprises a set of two dichroic mirrors placed in the highlighter optical path and configured to combine the paths of three primary colors into a common path.

23. A multicolored optical assembly according to aspect 22, wherein a first dichroic mirror is configured to combine two primary colours and a second dichroic mirror is configured to add a third primary colour to the combined two primary colours.

24. A multicolored optical assembly according to any of the previous aspects, wherein the baseline light beam is made from an aggregation of light beams with wavelengths in each of the primary colors, all the light beams of the aggregation of light beams are collected into a homogenization optics configured to deliver a combined beam having an etendue which is the same as the etendue of the highlighter light beam at the intermediate second target image, and which is smaller than ⅛^{th} of the etendue of an imager configured to form a final image and to provide the final image to a projection lens.

25. A multicolored optical assembly according to aspect 24, including an angular beam combination system wherein the baseline light beam and the highlighter light beam share a same size on the second intermediate target image, and wherein the baseline light beam and the highlighter light beam are combined via an inter-beam angle which is smaller than two times the angular dimensions of each of the individual highlighter light beam and the baseline light beam.

26. A multicolored optical assembly according to aspect 25, wherein a diffuser is located after the first intermediate target image or the second intermediate target image for spreading the angles at the plane of the first intermediate target image or second intermediate target image in such a way that the beam spread is within angular limits accepted by the imager and the projection lens.

27. A multicolored optical assembly according to any of the previous aspects, wherein the spatial phase modulator per color works with non-polarized or randomly polarized light.

28. A multicolored optical assembly according to any of the previous aspects, wherein the spatial phase modulator is a programmable lens or a dynamically addressable light steering component and is configured to receive a phase grating configured to create steering of the highlighter light beam to particular zones in the first intermediate target image, which zones are relayed, in one or more additional steps, onto an imager configured to form a final image.

29. A multicolored optical assembly according to any of the aspects 22 to 28, wherein highlighter light, reflected or transmitted after the highlighter light beam illuminates the spatial phase modulator, is reflected or transmitted and falls on the first intermediate target image in only one “steered” order, and the specularly reflected or transmitted unsteered light and non-diffracted light are incident on the first intermediate target image.

30. A multicolored optical assembly according to aspect 29, wherein one order of steered light falls on the first intermediate target image and other steered light diffraction orders are excluded from falling into the same area of the first intermediate target image.

31. A multicolored optical assembly according to aspect 30, wherein the specularly reflected or transmitted unsteered colour light is incident on the same first intermediate target image.

32. A multicolored optical assembly according to aspect 31, wherein converging steered light illumination is incident onto the active area of each spatial phase modulator.

33. A multicoloured optical assembly according to any of the previous aspects, wherein the combined beam is relayed to an imager.

34. A multicoloured optical assembly according to aspect 33, wherein the combined beam is passed from the imager to a projection lens.

35. A multicoloured optical assembly according to any of the previous aspects, wherein the highlighting peak factor is at least 5, 10, 20, 30, 40 or 50 or less.

36. A method for providing a highlighter light beam of steered light to a first intermediate target image, comprising the steps of:
generating a baseline light beam in a baseline optical path,
providing the highlighter light beam of steered light in a highlighter optical path,
combining the highlighter light beam of steered light with the baseline light beam to form a combined beam, the highlighter light beam being configured by the following steps per color:
   a multicolored laser source providing light to an integrator per colour,
   the integrator providing a homogenized and collimated beam for each colour,
   providing a spatial phase modulator per color in the highlighter optical path, wherein the homogenized and collimated beam for each colour is incident upon the spatial phase modulator and is phase modulated, for each colour, by the spatial phase modulator, each spatial phase modulator having an active spatial phase modulator area,
   realizing the highlighter light beam as a converging illumination onto a first intermediate target image,
wherein, for a first case, an illuminated area of the converged steered light illumination incident on the first target image is smaller than the active spatial phase modulator area, and/or,
   in a second case, converging the homogenized and collimated beam for each colour onto the spatial phase modulator,
   and realizing the converging steered light illumination in both cases in such a way that a specular beam of unsteered light of the highlighter beam is incident on and matches with a size of the first intermediate target image.

37. The method according to aspect 36, wherein for matching with a size of the first intermediate target image, the unsteered light is incident on the first intermediate target image in such a way that at least 85% of the first intermediate target image area is illuminated with at least 75% of the light intensity of the unsteered light that is incident at the center of the first intermediate target image.

38. The method according to aspect 36 or 37, wherein at least 85% of a complete flux of unsteered light is falling within the first intermediate target image area.

39. The method according to aspect 38, wherein converging steered light illumination is incident onto the active area of each spatial phase modulator.

40. The method according to aspect 38 or 39, wherein the steered light is converged by a lens.

41. The method according to any of the aspects 36 to 40, wherein the highlighter light beam is randomly polarized or is unpolarized.

42. The method according to any of the aspects 36 to 41, comprising constructing the baseline light beam from beams of three primary colour light sources which share a common integrator and combining the beams of the three primary colour light sources into a white beam.

43. The method according to any of the aspects 36 to 42, wherein the highlighter light beam has an illumination profile with a first resolution, and the highlighter light beam is combined with the baseliner light beam which has an optionally rectangular illumination profile, the combined beam being relayed to imagers that make an image having a second resolution higher than the first resolution.

44. The method according to any of the aspects 36 to 43, wherein the spatial phase modulator per colour is a piston based phase modulator.

45. The method according to any of the aspects 36 to 44, wherein the highlighter light beam and the baseline light beam are combined in angular space.

46. The method according to aspect 45, wherein the combined highlighter light beam and baseline light beam overlap in angular space after they have been combined and have passed a diffuser.

47. The method according to any of the aspects 43 to 46, comprising combining the highlighter light beam of steered light with the baseline light beam, and the highlighter light beam and baseliner light beam are converged at an included acute angle.

48. The method according to any of the aspects 36 to 47, further comprising an imager, and wherein at least one diffuser is in an optical path between the first intermediate target image and the imager, and wherein the diffuser increases the angular spread of the combined beam.

49. The method according to any of the aspects 36 to 48, comprising imaging the intermediate first target image on a second intermediate target image by a relay optical system and making the highlighter light beam telecentric.

50. The method according to any of the aspects 36 to 49, wherein the first intermediate target image is smaller than the active area of the spatial phase modulator by at least 5%, 10% or 15% or even smaller.

51. The method according to any of the aspects 36 to 50, wherein the integrator is an optical fiber.

52. The method according to aspect 51, wherein the optical fiber has a Beam Parameter Product of less than 50 mm·mrad.

53. The method according to aspect 51 or 52, wherein a cross-section of a core of the optical fibre is rectangular.

54. The method according to any of aspects 36 to 53, comprising illuminating the spatial phase modulator by incoming light, which is the homogenized and collimated beam for each colour, and the spatial phase modulator reflecting specularly reflected “unsteered” light to the first intermediate target image of the same size, and steering the incoming light to a single central spot in the first intermediate target image.

55. The method according to aspect 54, wherein the incoming light is the converged highlighter light beam incident onto the spatial phase modulator, and comprising reflecting the incoming light by the spatial phase modulator per colour, thereby further converging the highlighter light beam.

56. The method according to any of the aspects 36 to 55, wherein converging of the highlighter light beam to reduce from the size of the active area of the spatial phase modulator to the size of the first intermediate target image is by a convex lens just in front of the spatial phase modulator.

57. The method according to any of the aspects 36 to 56, further comprising combining three coloured baseline light beams from the baseline optical path with three coloured highlighter light beams from the highlighter optical path by a beam combination system, the beam combination system being located between the spatial phase modulator of each color and a second intermediate target image, in such a way that the three coloured highlighter light beams share a same highlighter optical path when arriving at a second intermediate target image.

58. The method according to aspect 57, comprising combining the three coloured baseline light beams from the baseline optical path with three coloured highlighter light beams from the highlighter optical path via a set of two dichroic mirrors of the beam combination system and placed in the highlighter optical path per colour between the spatial phase modulator of that colour and a common second intermediate image, in such a way that the three colour beams share the same optical axis when arriving at the second intermediate image.

59. The method according to aspect 58, comprising a first dichroic mirror combining red and green beams, a second dichroic mirror also adding a blue beam to the combined red and green beam.

60. The method according to aspect 58 or 59, wherein the first or second dichroic mirror is put at 45° to the beam direction so that one beam of one colour passes through the first dichroic mirror and a second beam presented in a perpendicular direction is reflected into the same direction on the same optical axis.

61. The method according to any of the aspects 36 to 60, wherein the baseline light beam is made from an aggregation of light beams with wavelengths in each of the primary colors, and wherein all the light beams of the aggregation are collected into a homogenization optics delivering a combined beam having an etendue similar to the etendue of the highlighter light beam at the second intermediate target image, and smaller than ⅛^{th} of the etendue of an imager that forms a final image and provides the finale image to a projection lens.

62. The method according to aspect 61, including an angular beam combination system wherein the baseline light beam and highlighter light beam share a same size on the second intermediate target image, and wherein the baseline light beam and the highlighter light beam are combined via an inter-beam angle which is smaller than two times the angular dimensions of each of the individual highlighter light beam and the baseline light beam.

63. The method according to aspect 62, comprising spreading the angles at the plane of the first intermediate target image or the second intermediate target image by a diffuser located after the first intermediate target image or the second intermediate target image, in such a way that the beam spread is within angular limits accepted by the imager and the projection lens.

64. The method according to any of the aspects 36 to 63, wherein the spatial phase modulator per color works with non-polarized or randomly polarized light.

65. The method according to any of the aspects 36 to 64v, wherein the spatial phase modulator is a programmable lens or a dynamically addressable light steering component and receives a phase grating creating steering of the highlighter light beam to particular zones in the first intermediate target image, which zones are relayed, in one or more additional steps, onto an imager forming a final image.

66. The method according to any of the aspects 59 to 65, wherein highlighter light, reflected or transmitted after the highlighter light beam illuminates the spatial phase modulator, is reflected or transmitted and falls on the first intermediate target image in only one “steered” order, and the unsteered light which is specularly reflected or transmitted and non-diffracted light are incident on the first intermediate target image.

67. The method according to any of the aspects 36 to 66, wherein the combined beam is relayed to an imager.

68. The method in accordance with aspect 67, wherein the combined beam is passed from the imager to a projection lens.

69. The method according to any of the aspects 36 to 68, wherein the highlighting peak factor of the highlighter light beam is at least 5, 10, 20, 30, 40 or 50 or less.

70. A controller comprising a digital processing device, the controller being adapted to control the operation of spatial phase modulators in a projector having a baseline light beam and a highlighter light beam, the controller being adapted to control the spatial phase modulators to generate dynamically varying steered light and unsteered light from the highlighter light beam, and to control spatial light modulators to generate images for projection from a combination of the non-steered light, the steered light and the baseline light beam, the steered light creating highlights in the images.

1-70. (canceled)

71. A multicolored optical assembly for providing a highlighter light beam of steered light to a first intermediate target image, comprising a baseline optical path generating a baseline light beam, the optical assembly having a highlighter optical path providing the highlighter light beam of steered light, the assembly being configured to combine the highlighter light beam of steered light with the baseline light beam to form a combined beam, wherein the multicolored optical assembly is adapted to configure the highlighter light beam by the following per color:
a multicolored laser source providing light to an integrator per colour, the integrator providing a homogenized and collimated beam for each colour,
a spatial phase modulator per color in the highlighter optical path, wherein the homogenized and collimated beam for each colour is incident upon the spatial phase modulator and is phase modulated for each colour by the spatial phase modulator, per colour, each spatial phase modulator having an active spatial phase modulator area,
means for converging steered light of the highlighter beam to be incident on a first intermediate target image,
wherein, in a first case, an illuminated area of the converged steered light illumination incident on the first intermediate target image is smaller than the active spatial phase modulator area, and/or,
in a second case, the means for converging is configured for converging the homogenized and collimated beam for each colour onto the spatial phase modulator,
and for both cases, the converged steered light illumination is realized in such a way that a specular beam of unsteered light of the highlighter light beam matches with a size of the first intermediate target image.

72. The multicolored optical assembly according to claim 71, wherein for matching with a size of the first target image, the unsteered light is landing on the first intermediate target image in such a way that at least 85% of the first target image area is illuminated with at least 75% of the light intensity of the unsteered light that is incident at the center of the first intermediate target image.

73. The multicolored optical assembly according to claim 71, wherein at least 85% of a complete flux of unsteered light is falling within the first intermediate target image area.

74. The multicolored optical assembly according to claim 71, wherein the highlighter light beam is randomly polarized or is unpolarized.

75. The multicolored optical assembly according to claim 71, wherein the baseline light beam is constructed from beams of three primary colour light sources which share a common integrator and are combined into a white beam.

76. The multicolored optical assembly according to claim 71, wherein the highlighter light beam has an illumination profile with a first resolution, and the highlighter light beam is combined with the baseliner light beam which has an optionally rectangular illumination profile, and wherein the combined beam is relayed to imagers that make an image having a second resolution higher than the first resolution.

77. The multicolored optical assembly according to claim 71, wherein the spatial phase modulator per colour is a piston based spatial phase modulator.

78. The multicolored optical assembly according to claim 71, wherein the highlighter light beam and the baseline light beam are combined in an angular space.

79. The multicolored optical assembly according to claim 78, comprising a diffuser and wherein the combined highlighter and baseline light beams overlap in the angular space after they have been combined and have passed the diffuser.

80. The multicolored optical assembly according to claim 71, further comprising an imager, and wherein at least one diffuser is in an optical path between the first intermediate target image and the imager, and wherein the diffuser increases the angular spread of the combined beam.

81. The multicolored optical assembly according to claim 71, further comprising a relay optical system that images the first target image on a second target image and wherein the highlighter light beam is made telecentric.

82. The multicolored optical assembly according to claim 71, wherein the first target intermediate image is smaller than the active area of the spatial phase modulator by at least 5%, 10% or 15% or even smaller.

83. The multicolored optical assembly according to claim 71, wherein the integrator in the highlighter optical path is an optical fiber.

84. The multicolored optical assembly according to claim 71, wherein the spatial phase modulator is illuminated by incoming light, which is the homogenized and collimated beam for each colour, and reflects specularly reflected “unsteered” light to the first intermediate target image of the same size, and wherein the spatial phase modulator is configured to steer the incoming light to a single central spot in the first intermediate target image.

85. The multicolored optical assembly according to claim 71, further comprising a beam combination system that is configured to combine three coloured baseline light beams from the baseline optical path with three coloured highlighter light beams from the highlighter optical path, and wherein the beam combination system is located between the spatial phase modulator of each colour and a second target image, in such a way that the three coloured highlighter light beams share a same highlighter optical path when arriving at a second target image.

86. The multicolored optical assembly according to claim 71, wherein the baseline light beam is made from an aggregation of light beams with wavelengths in each of the primary colors, all the light beams of the aggregation of light beams are collected into a homogenization optics configured to deliver a combined beam having an etendue which is the same as the etendue of the highlighter light beam at the intermediate second target image, and which is smaller than ⅛^{th} of the etendue of an imager configured to form a final image and to provide the final image to a projection lens.

87. The multicolored optical assembly according to claim 71, wherein the spatial phase modulator is a programmable lens or a dynamically addressable light steering component and is configured to receive a phase grating configured to create steering of the highlighter light beam to particular zones in the first intermediate target image, which zones are relayed, in one or more additional steps, onto an imager configured to form a final image.

88. The multicolored optical assembly according to claim 71, wherein the highlighting peak factor is at least 5, 10, 20, 30, 40 or 50 or less.

89. A method for providing a highlighter light beam of steered light to a first intermediate target image, comprising the steps of:
generating a baseline light beam in a baseline optical path,
providing the highlighter light beam of steered light in a highlighter optical path,
combining the highlighter light beam of steered light with the baseline light beam to form a combined beam, the highlighter light beam being configured by the following steps per color:
a multicolored laser source providing light to an integrator per colour,
the integrator providing a homogenized and collimated beam for each colour,
providing a spatial phase modulator per color in the highlighter optical path, wherein the homogenized and collimated beam for each colour is incident upon the spatial phase modulator and is phase modulated, for each colour, by the spatial phase modulator, each spatial phase modulator having an active spatial phase modulator area,
realizing the highlighter light beam as a converging illumination onto a first intermediate target image,
wherein, for a first case, an illuminated area of the converged steered light illumination incident on the first target image is smaller than the active spatial phase modulator area, and/or,
in a second case, converging the homogenized and collimated beam for each colour onto the spatial phase modulator,
and realizing the converging steered light illumination in both cases in such a way that a specular beam of unsteered light of the highlighter beam is incident on and matches with a size of the first intermediate target image.

90. A controller comprising a digital processing device, the controller being adapted to control the operation of spatial phase modulators in a projector having a baseline light beam and a highlighter light beam, the controller being adapted to control the spatial phase modulators to generate dynamically varying steered light and unsteered light from the highlighter light beam, and to control spatial light modulators to generate images for projection from a combination of the non-steered light, the steered light and the baseline light beam, the steered light creating highlights in the images.
